(19) United States
(12) Patent Application Publication
(10) Pub. No.: US 2011/0034651 A1
(43) Pub. Date: Feb. 10, 2011

(54) MIXED DONOR SYSTEM FOR HIGH MELT FLOW AND HIGH ACTIVITY

(75) Inventor: Neil O'Reilly, Houston, TX (US)

Correspondence Address: BASF CATALYSTS LLC, 100 CAMPUS DRIVE, FLORHAM PARK, NJ, 07932, US

(73) Assignee: BASF CATALYSTS LLC, Florham Park, NJ (US)

(21) Appl. No.: 12/536,692

(22) Filed: Aug. 6, 2009

(51) Int. Cl. C08F 4/00; C08F 4/44

(52) U.S. Cl. 526/126; 502/103

(57) ABSTRACT

Disclosed are catalyst systems and methods of using the same for the polymerization of an olefin containing a solid titanium catalyst ant two external electron donors. Use of an aminosilane and an alkylsilane as external electron donors provide for high hydrogen response, high isotacticity, and high activity.

### TECHNICAL FIELD

The subject innovation generally relates to olefin polymerization catalyst systems and methods of making the catalyst systems and olefin polymers and copolymers using the catalyst systems.

### BACKGROUND

Polyolefins are a class of polymers derived from simple olefins. Known methods of making polyolefins involve the use of Ziegler-Natta polymerization catalysts. These catalysts polymerize vinyl monomers using a transition metal halide to provide an istotactic polymer.

Numerous Ziegler-Natta polymerization catalysts exist. The catalysts have different characteristics and/or lead to the production of polyolefins having diverse properties. For example, certain catalysts have high activity while other catalysts have low activity. Moreover, polyolefins made with the use of Ziegler-Natta polymerization catalysts vary in isotacticity, molecular weight distribution, impact strength, melt-flowability, rigidity, heat sealability, isotacticity, and the like.

### SUMMARY

The following presents a simplified summary of the innovation in order to provide a basic understanding of some aspects of the innovation. This summary is not an extensive overview of the innovation. It is intended to neither identify key or critical elements of the innovation nor delineate the scope of the innovation. Rather, the sole purpose of this summary is to present some concepts of the innovation in a simplified form as a prelude to the more detailed description that is presented hereinafter.

The subject innovation provides olefin polymerization catalyst systems, methods of making the olefin polymerization catalyst systems, and methods of polymerizing (and copolymerizing) olefins using catalysts having high activity, high isotacticity, and high hydrogen response (melt flow of polymer produced as a function of hydrogen concentration). The methods of making a polyolefin can involve contacting an olefin with a solid titanium catalyst component, an organoaluminum compound, and the external electron donors described herein. Specific combinations of external electron donors, as described herein, improve catalytic activity and/or hydrogen response of the solid titanium catalyst system.

One aspect of the invention is directed toward a catalyst system for polymerizing an olefin to form a polyolefin. The catalyst system has a solid titanium catalyst component, the solid titanium catalyst component having a titanium compound and a support made from a magnesium compound. In addition to the solid titanium catalyst, the catalyst system has an organoaluminum compound having at least one aluminum-carbon bond and at least two organosilicon compounds in a specified mole ratio, wherein one of the at least two organosilicon compounds is an aminosilane and another of the at least two organosilicon compounds is an alkylsilane.

Another aspect of the invention is directed toward a catalyst system having a Ziegler-Natta catalyst and at least two organosilicon compounds in a specified mole ratio, wherein one of the at least two organosilicon compounds is an aminosilane and another of the at least two organosilicon compounds is an alkylsilane. The catalyst system can have a property that when the catalyst system is contacted with an olefin monomer and a pressure of about 3.0 Mpa or less, the ratio of MFR for the polyolefin expressed in units of g (10 min)⁻¹ to the mole percentage of hydrogen, expressed in percent units, is greater than about 14:1.

In yet another aspect of the invention is directed toward methods of making a polyolefin. An olefin is contacted with a catalyst system having a solid titanium catalyst component, the solid titanium catalyst component having a titanium compound and a support; and at least two organosilicon compounds, wherein one of the at least two organosilicon compounds is an alkylsilane.

In still yet another aspect of the invention is directed toward a multidonor catalyst system having a solid titanium catalyst component comprising a titanium compound and a support; an organoaluminum compound having at least one aluminum-carbon bond; and a first external electron donor and a second external electron donor. The first external electron donor combined with a reference system produces a first polyolefin having a melt flow rate of MFR(1), and the second electron donor combined with the reference system produces a second polyolefin having a melt flow rate of MFR(2), where the reference system includes the solid titanium catalyst and the organoaluminum compound. The molar amount of the first external electron donor present in the multidonor catalyst system is greater than the molar amount of the second external electron donor present in the multidonor catalyst system, and the value of log [MFR(1)/MFR(2)] is from about 0.5 to about 0.8.

To the accomplishment of the foregoing and related ends, the innovation contains the features hereinafter fully described and particularly pointed out in the claims. The following description and the annexed drawings set forth in detail certain illustrative aspects and implementations of the innovation. These are indicative, however, of but a few of the various ways in which the principles of the innovation may be employed. Other objects, advantages and novel features of the innovation will become apparent from the following detailed description of the innovation when considered in conjunction with the drawings.

### BRIEF SUMMARY OF THE DRAWINGS

FIG. 1 is a high level schematic diagram of an olefin polymerization system in accordance with one aspect of the subject innovation.

FIG. 2 is a schematic diagram of an olefin polymerization reactor in accordance with one aspect of the subject innovation.

FIG. 3 is a high level schematic diagram of a system for making impact copolymer in accordance with one aspect of the subject innovation.

FIG. 4 depicts a graph of hydrogen response of catalysts according to aspects of the invention.

FIG. 5 depicts a graph of instantaneous reaction activity versus time for a polymerization reaction according to an aspect of the invention.

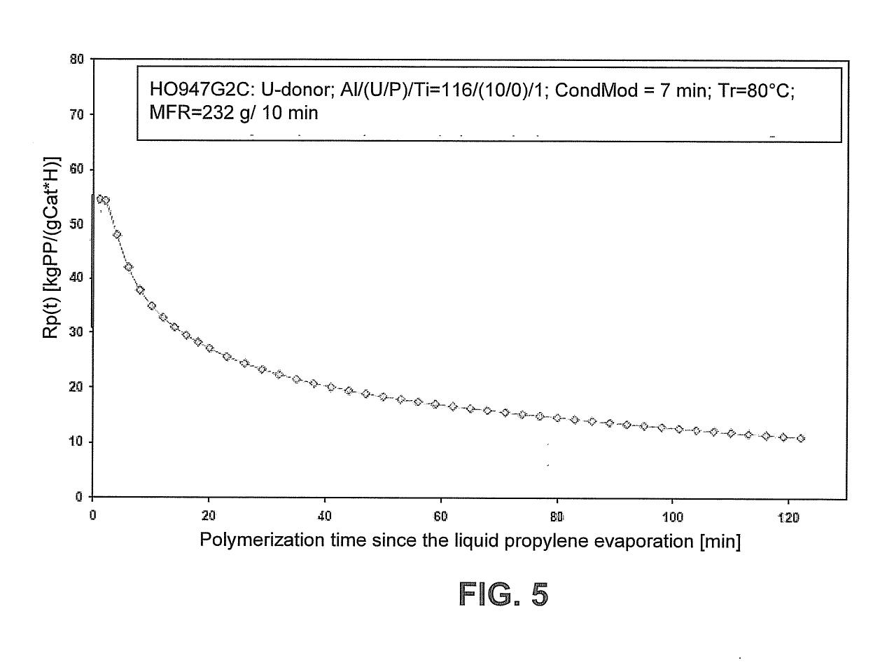

### DETAILED DESCRIPTION

The subject innovation relates to catalyst systems, methods of making catalyst systems, and methods of making polyolefins. An aspect of the innovation is a catalyst system for polymerizing an olefin containing a solid titanium catalyst component containing a titanium compound and a support made from a magnesium compound, and at least two organosilicon compounds that serve as external electron donors. Use of specific combinations of external electron donors within the catalyst system can result in a catalyst system having improved catalytic activity and hydrogen response compared to any of the component external electron donors employed individually.

The slurry catalyst system can contain any suitable liquid such as inert hydrocarbon medium. Examples of inert hydrocarbon media include aliphatic hydrocarbons such as propane, butane, pentane, hexane, heptane, octane, decane, dodecane and kerosene; alicyclic hydrocarbons such as cyclopentane, cyclohexane and methylcyclopentane; aromatic hydrocarbons such as benzene, toluene and xylene; halogenated hydrocarbons such as ethylene chloride and chlorobenzene; and mixtures thereof. The slurry medium is typically hexane, heptane or mineral oil.

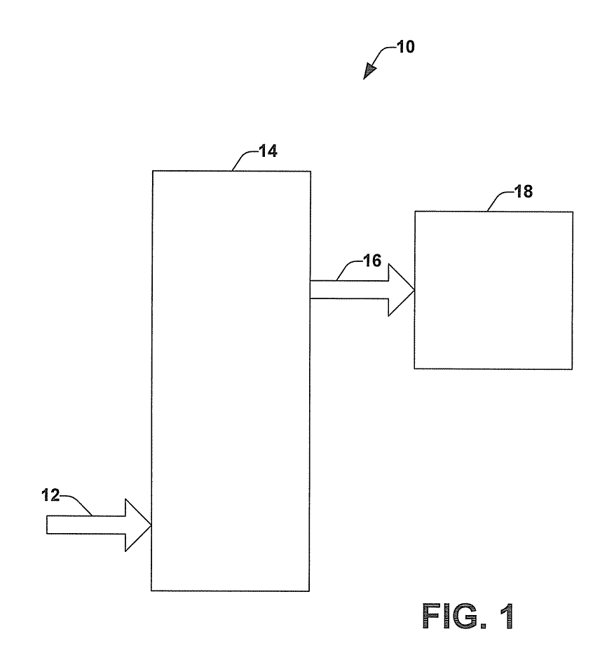

The catalyst system can be used in polymerization of olefins in any suitable system/process. Examples of systems for polymerizing olefins are now described. Referring to FIG. 1, a high level schematic diagram of a system 10 for polymerizing olefins is shown. Inlet 12 is used to introduce catalyst system components into a reactor 14; catalyst system components can include olefins, optional comonomers, hydrogen gas, fluid media, pH adjusters, surfactants, and any other additives. Although only one inlet is shown, many are often employed. Reactor 14 is any suitable vehicle that can polymerize olefins. Examples of reactors 14 include a single reactor, a series of two or more reactors, slurry reactors, fixed bed reactors, gas phase reactors, fluidized gas reactors, loop reactors, multizone circulating reactors, and the like. Once polymerization is complete, or as polyolefins are produced, the polymer product is removed from the reactor 14 via outlet 16 which leads to a collector 18. Collector 18 can include downstream processing, such as heating, extrusion, molding, and the like.

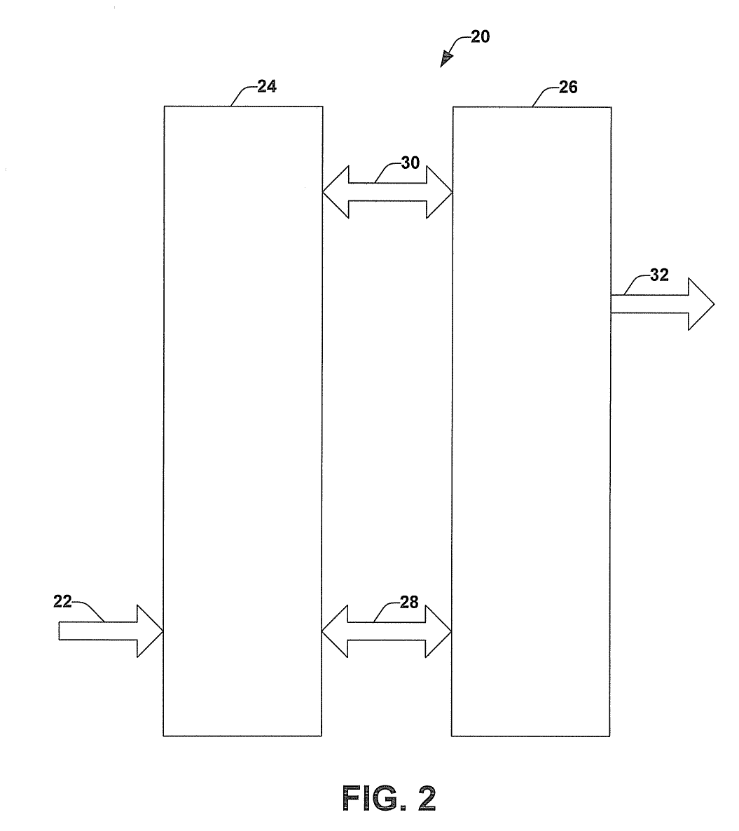

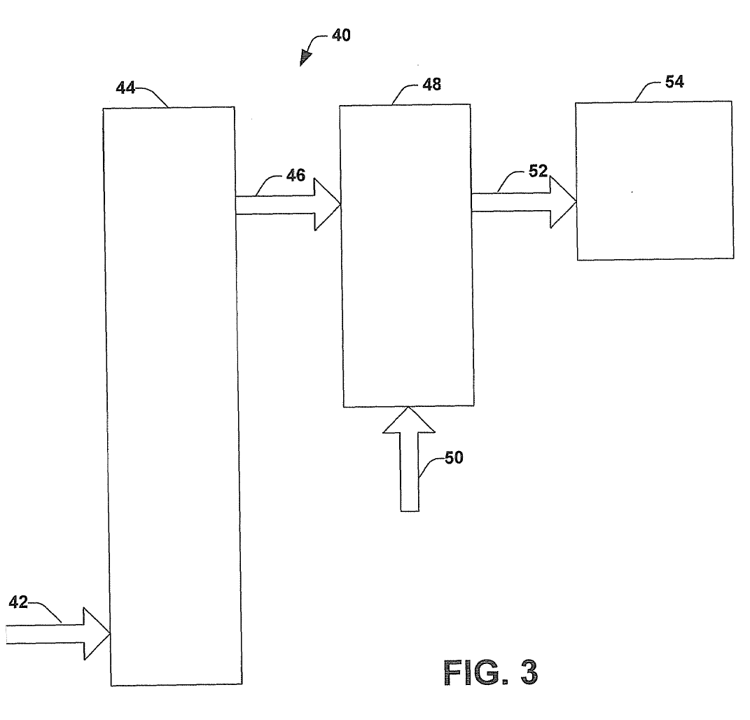

Referring to FIG. 2, a schematic diagram of a multizone circulating reactor 20 that can be employed as the reactor 14 in FIG. 1 or reactor 44 in FIG. 3 for making polyolefins is shown. The multizone circulating reactor 20 substitutes a series of separate reactors with a single reactor loop that permits different gas phase polymerization conditions in the two sides due to use of a liquid barrier. In the multizone circulating reactor 20, a first zone starts out rich in olefin monomer, and optionally one or more comonomers. A second zone is rich in hydrogen gas, and a high velocity gas flow divides the growing resin particles out loosely. The two zones produce resins of different molecular weight and/or monomer composition. Polymer granules grow as they circulate around the loop, building up alternating layers of each polymer fraction in an onion like fashion. Each polymer particle constitutes an intimate combination of both polymer fractions.

In operation, the polymer particles pass up through the fluidizing gas in an ascending side 24 of the loop and come down through the liquid monomer on a descending side 26. The same or different monomers (and again optionally one or more comonomers) can be added in the two reactor legs. The reactor uses the catalyst systems described above.

In the liquid/gas separation zone 30, hydrogen gas is removed to cool and recirculate. Polymer granules are then packed into the top of the descending side 26, where they then descend. Monomers are introduced as liquids in this section. Conditions in the top of the descending side 26 can be varied with different combinations and/or proportions of monomers in successive passes.

Referring to FIG. 3, a high level schematic diagram of another system 40 for polymerizing olefins is shown. This system is ideally suited to make impact copolymer. A reactor 44, such as a single reactor, a series of reactors, or the multizone circulating reactor is paired with a gas phase or fluidized bed reactor 48 downstream containing the catalyst systems described above to make impact copolymers with desirable impact to stiffness balance or greater softness than are made with conventional catalyst systems. Inlet 42 is used to introduce into the reactor 44 catalyst system components, olefins, optional comonomers, hydrogen gas, fluid media, pH adjusters, surfactants, and any other additives. Although only one inlet is shown, many often are employed. Through transfer means 46 the polyolefin made in the first reactor 44 is sent to a second reactor 48. Feed 50 is used to introduce catalyst system components, olefins, optional comonomers, fluid media, and any other additives. The second reactor 48 may or may not contain catalyst system components. Again, although only one inlet is shown, many often are employed. Once the second polymerization is complete, or as impact copolymers are produced, the polymer product is removed from the second reactor 48 via outlet 52 which leads to a collector 54. Collector 54 may include downstream processing, such as heating, extrusion, molding, and the like. At least one of the first reactor 44 and the second reactor 48 contains catalyst systems in accordance with the innovation.

When making an impact copolymer, polypropylene can be formed in the first reactor while an ethylene propylene rubber can be formed in the second reactor. In this polymerization, the ethylene propylene rubber in the second reactor is formed with the matrix (and particularly within the pores) of the polypropylene formed in the first reactor. Consequently, an intimate mixture of an impact copolymer is formed, wherein the polymer product appears as a single polymer product. Such an intimate mixture cannot be made by simply mixing a polypropylene product with an ethylene propylene rubber product.

Although not shown in any of the figures, the systems and reactors can be controlled, optionally with feedback based on continuous or intermittent testing, using a processor equipped with an optional memory and controllers. For example, a processor can be connected to one or more of the reactors, inlets, outlets, testing/measuring systems coupled with the reactors, and the like to monitor and/or control the polymerization process based on preset data concerning the reactions, and/or based on testing/measuring data generated during a reaction. The controller may control valves, flow rates, the amounts of materials entering the systems, the conditions (temperature, reaction time, pH, etc.) of the reactions, and the like, as instructed by the processor. The processor may contain or be coupled to a memory that contains data concerning various aspects of the polymerization process and/or the systems involved in the polymerization process.

The subject innovation can be applied to any suitable Ziegler-Natta polymerization catalyst system. Ziegler-Natta catalysts are comprised of a reagent or combination of reagents that are functional to catalyze the polymerization of 1-alkenes (α-olefins) to form polymers, typically with high isotacticity when pro-chiral 1-alkenes are polymerized. A Ziegler-Natta catalyst has a transition metal component, a main group metal alkyl component, and an electron donor; as used herein, the term “Ziegler-Natta catalyst” refers to any composition having a transition metal and a main group metal alkyl component capable of supporting polymerization of 1-alkenes. The transition metal component is typically a Group IV metal such as titanium or vanadium, the main group metal alkyl is typically an organoaluminum compound having a carbon-Al bond, and the electron donor can be any of numerous compounds including aromatic esters, alkoxysilanes, amines and ketones can be used as external donors added to the transition metal component and the main group metal alkyl component or an appropriate internal donor added to the transition metal component and the main group metal alkyl component during synthesis of those components. The details of the constituent, structure, and manufacture of the Ziegler-Natta polymerization catalyst system are not critical to the practice of the subject innovation, provided that the Ziegler-Natta polymerization catalyst system has two or more organosilicon compounds serving as external electron donors as described herein. The details of the constituent, structure, and manufacture of the Ziegler-Natta polymerization catalyst system can be found in, for example, U.S. Patents and U.S. Patent Publications: U.S. Pat. Nos. 4,771,023; 4,784,983; 4,829,038; 4,861,847; 4,990,479; 5,177,043; 5,194,531; 5,244,989; 5,438,110; 5,489,634; 5,576,259; 5,767,215; 5,773,537; 5,905,050; 6,323,152; 6,437,061; 6,469,112; 6,962,889; 7,135,531; 7,153,803; 7,271,119; 2004/242406; 2004/0242407; and 2007/0021573, all of which are hereby incorporated by reference in this regard.

The solid titanium catalyst component used in subject innovation is a highly active catalyst component containing at least titanium, an optional external electron donor, and a magnesium containing catalyst support.

The solid titanium catalyst component can be prepared by contacting a catalyst support made with a magnesium compound, as described above, and a titanium compound. The titanium compound used in the preparation of the solid titanium catalyst component in the subject innovation is, for example, a tetravalent titanium compound represented by Formula (I)

Ti(OR)_{g}X_{4-g} (I)

wherein each R group independently represents a hydrocarbon group, preferably an alkyl group having 1 to about 4 carbon atoms, X represents a halogen atom, and 0 [symbol] g≦4. Specific examples of the titanium compound include titanium tetrahalides such as TiCl₄, TiBr₄ and TiI₄; alkoxytitanium trihalides such as Ti(OCH₃)Cl₃, Ti(OC₂H₅)Cl₃, Ti(O n-C₄H₉)Cl₃, Ti(OC₂H₅)Br₃ and Ti(O iso-C₄H₉)Br₃; dialkoxytitanium dihalides such as Ti(OCH₃)₂ Cl₂, Ti(OC₂H₅)₂Cl₂, Ti(O n-C₄H₉)₂Cl₂ and Ti(OC₂H₅)₂Br₂; trialkoxytitanium monohalides such as Ti(OCH₃)₃Cl, Ti(OC₂H₅)₃Cl, Ti(O n-C₄H₉)₃Cl and Ti(OC₂H₅)₃Br; and tetraalkoxytitaniums such as Ti(OCH₃)₄, Ti(OC₂H₅)₄, Ti(OC₃H₇)₃Cl, Ti(OC₃H₇)₂Cl₂, Ti(O n-C₄H₉)₄.

Among these, the halogen containing titanium compounds, especially titanium tetrahalides, are preferred in some instances. These titanium compounds may be used individually or in a combination of two or more. They also can be used as dilutions in hydrocarbon compounds or halogenated hydrocarbons.

When preparing the solid titanium catalyst component, an optional internal electron donor is used/added. Internal electron donors, for example, oxygen-containing electron donors such organic acid esters, polycarboxylic acid esters, polyhydroxy ester, heterocyclic polycarboxylic acid esters, inorganic acid esters, alicyclic polycarboxylic acid esters and hydroxy-substituted carboxylic acid esters compounds having 2 to about 30 carbon atoms such as methyl formate, ethyl acetate, vinyl acetate, propyl acetate, octyl acetate, cyclohexyl acetate, ethyl propionate, methyl butyrate, ethyl valerate, ethyl stearate, methyl chloroacetate, ethyl dichloroacetate, methyl methacrylate, ethyl crotonate, dibutyl maleate, diethyl butylmalonate, diethyl dibutylmalonate, ethyl cyclohexanecarboxylate, diethyl 1,2-cyclohexanedicarboxylate, di-2-ethylhexyl 1,2-cyclohexanedicarboxylate, methyl benzoate, ethyl benzoate, propyl benzoate, butyl benzoate, octyl benzoate, cyclohexyl benzoate, phenyl benzoate, benzyl benzoate, methyl toluate, ethyl toluate, amyl toluate, ethyl ethylbenzoate, methyl anisate, ethyl anisate, ethyl ethoxybenzoate, dimethyl phthalate, diethyl phthalate, dipropyl phthalate, diisopropyl phthalate, dibutyl phthalate, diisobutyl phthalate, dioctyl phthalate, γ-butyrolactone, δ-valerolactone, coumarine, phthalide, ethylene carbonate, ethyl silicate, butyl silicate, vinyltriethoxysilane, phenyltriethoxysilane and diphenyldiethoxysilane; alicyclic polycarboxylic acid esters such as diethyl 1,2-cyclohexanecarboxylate, diisobutyl 1,2-cyclohexanecarboxylate, diethyl tetrahydrophthalate and nadic acid, diethyl ester; aromatic polycarboxylic acid esters such as monoethyl phthalate, dimethyl phthalate, methylethyl phthalate, monoisobutyl phthalate, mono-n-butyl phthalate, diethyl phthalate, ethyl isobutyl phthalate, ethyl-n-butyl phthalate, di-n-propyl phthalate, diisopropyl phthalate, di-n-butyl phthalate, diisobutyl phthalate, di-n-heptyl phthlate, di-2-ethylhexyl phthalate, di-n-octyl phthalate, dineopentyl phthalate, didecyl phthalate, benzylbutyl phthalate, diphenyl phthalate, diethyl naphthalenedicarboxylate, dibutyl naphthlenedicarboxylate, triethyl trimelliatate and dibutyl trimellitate, 3,4-furanedicarboxylic acid esters, 1,2-diacetoxybenzene, 1-methyl-2,3-diacetoxybenzene, 2-methyl-2,3-diacetoxybenzene, 2,8-diacetoxynaphthalene, ethylene glycol dipivalate, butanediol pivalate, benzoylethyl salicylate, acetylisobutyl salicylate and acetylmethyl salicylate.

Long-chain dicarboxylic acid esters, such as diethyl adipate, diisobutyl adipate, diisopropyl sebacate, di-n-butyl sebacate, di-n-octyl sebacate and di-2-ethylhexyl sebacate, may also be used as the polycarboxylic acid esters that can be included in the titanium catalyst component. Among these polyfunctional esters, compounds having the skeletons given by the above general formulae are preferred. Also preferred are esters formed between phthalic acid, maleic acid or substituted malonic acid and alcohols having at least about 2 carbon atoms, diesters formed between phthalic acid and alcohols having at least about 2 carbon atoms are especially preferred. Monocarboxylic acid esters represented by RCOOR′ where R and R′ are hydrocarbonyl groups that can have a substituent, and at least one of them is a branched or ring-containing aliphatic group alicyclic. Specifically, at least one of R and R′ may be (CH₃)₂CH—, C₂H₅CH(CH₃)—, (CH₃)₂CHCH₂—, (CH₃)₃C—, C₂H₅CH₂—, (CH₃)CH₂—, cyclohexyl, methylbenzyl, para-xylyl, acrylic, and carbonylbenzyl. If either one of R and R′ is any of the above-described group, the other may be the above group or another group such as a linear or cyclic group. Specific examples of the monocarboxylic acid esters include monoesters of dimethylacetic acid, trimethylacetic acid, alpha-methylbutyric acid, beta-methylbutyric acid, methacrylic acid and benzoylacetic acid; and monocarboxylic acid esters formed with alcohols such as methanol, ethanol, isopropanol, isobutanol and tert-butanol.

Additional useful internal electron donors include internal electron donors containing at least one ether group and at least one ketone group. That is, the internal electron donor compound contains in its structure at least one ether group and at least one ketone group.

Examples of internal electron donors containing at least one ether group and at least one ketone group include compounds of the following Formula (II).

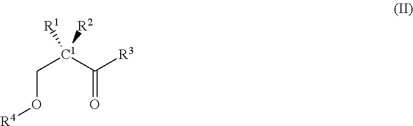

wherein R¹, R², R³, and R⁴ are identical or different, and each represents a substituted or unsubstituted hydrocarbon group. In one embodiment, the substituted or unsubstituted hydrocarbon group includes from 1 to about 30 carbon atoms. In another embodiment, R¹, R², R³, and R⁴ are identical or different, and each represents a linear or branched alkyl group containing from 1 to about 18 carbon atoms, a cycloaliphatic group containing from about 3 to about 18 carbon atoms, an aryl group containing from about 6 to about 18 carbon atoms, an alkylaryl group containing from about 7 to about 18 carbon atoms, and an arylalkyl group containing from about 7 to about 18 carbon atoms. In yet another embodiment, R¹, C¹ and R² are a part of a substituted or unsubstituted cyclic or polycyclic structure containing from about 5 to about 14 carbon atoms. In still yet another embodiment, the cyclic or polycyclic structure has one or more substitutes selected from the group consisting of a linear or branched alkyl group containing from 1 to about 18 carbon atoms, a cycloaliphatic group containing from about 3 to about 18 carbon atoms, an aryl group containing from about 6 to about 18 carbon atoms, an alkylaryl group containing from about 7 to about 18 carbon atoms, and an arylalkyl group containing from about 7 to about 18 carbon atoms.

Specific examples of internal electron donors containing at least one ether group and at least one ketone group include 9-(alkylcarbonyl)-9′-alkoxymethylfluorene including 9-(methylcarbonyl)-9′-methoxymethylfluorene, 9-(methylcarbonyl)-9′-ethoxymethylfluorene, 9-(methylcarbonyl)-9′-propoxymethylfluorene, 9-(methylcarbonyl)-9′-butoxymethylfluorene, 9-(methylcarbonyl)-9′-pentoxymethylfluorene, 9-(ethylcarbonyl)-9′-methoxymethylfluorene, 9-(ethylcarbonyl)-9′-ethoxymethylfluorene, 9-(ethylcarbonyl)-9′-propoxymethylfluorene, 9-(ethylcarbonyl)-9′-butoxymethylfluorene, 9-(ethylcarbonyl)-9′-pentoxymethylfluorene, 9-(propylcarbonyl)-9′-methoxymethylfluorene, 9-(propylcarbonyl)-9′-ethoxymethylfluorene, 9-(propylcarbonyl)-9′-propoxymethylfluorene, 9-(propylcarbonyl)-9′-butoxymethylfluorene, 9-(propylcarbonyl)-9′-pentoxymethylfluorene, 9-(butylcarbonyl)-9′-methoxymethylfluorene, 9-(butylcarbonyl)-9′-ethoxymethylfluorene, 9-(butylcarbonyl)-9′-propoxymethylfluorene, 9-(butylcarbonyl)-9′-butoxymethylfluorene, 9-(butylcarbonyl)-9′-pentoxymethylfluorene, 9-(pentylcarbonyl)-9′-methoxymethylfluorene, 9-(pentylcarbonyl)-9′-ethoxymethylfluorene, 9-(pentylcarbonyl)-9′-propoxymethylfluorene, 9-(pentylcarbonyl)-9′-butoxymethylfluorene, 9-(pentylcarbonyl)-9′-pentoxymethylfluorene, 9-(hexylcarbonyl)-9′-methoxymethylfluorene, 9-(hexylcarbonyl)-9′-ethoxymethylfluorene, 9-(hexylcarbonyl)-9′-propoxymethylfluorene, 9-(hexylcarbonyl)-9′-butoxymethylfluorene, 9-(hexylcarbonyl)-9′-pentoxymethylfluorene, 9-(octylcarbonyl)-9′-methoxymethylfluorene, 9-(octylcarbonyl)-9′-ethoxymethylfluorene, 9-(octylcarbonyl)-9′-propoxymethylfluorene, 9-(octylcarbonyl)-9′-butoxymethylfluorene, 9-(octylcarbonyl)-9′-pentoxymethylfluorene; 9-(i-octylcarbonyl)-9′-methoxymethylfluorene, 9-(i-octylcarbonyl)-9′-ethoxymethylfluorene, 9-(i-octylcarbonyl)-9′-propoxymethylfluorene, 9-(i-octylcarbonyl)-9′-butoxymethylfluorene, 9-(i-octylcarbonyl)-9′-pentoxymethylfluorene; 9-(i-nonylcarbonyl)-9′-methoxymethylfluorene, 9-(i-nonylcarbonyl)-9′-ethoxymethylfluorene, 9-(i-nonylcarbonyl)-9′-propoxymethylfluorene, 9-(i-nonylcarbonyl)-9′-butoxymethylfluorene, 9-(i-nonylcarbonyl)-9′-pentoxymethylfluorene; 9-(2-ethyl-hexylcarbonyl)-9′-methoxymethylfluorene, 9-(2ethyl-hexylcarbonyl)-9′-ethoxymethylfluorene, 9-(2-ethyl-hexylcarbonyl)-9′-propoxymethylfluorene, 9-(2-ethyl-hexylcarbonyl)-9′-butoxymethylfluorene, 9-(2-ethyl-hexylcarbonyl)-9′-pentoxymethylfluorene, 9-(phenylketone)-9′-methoxymethylfluorene, 9-(phenylketone-9′-ethoxymethylfluorene, 9-(phenylketone)-9′-propoxymethylfluorene, 9-(phenylketone)-9′-butoxymethylfluorene, 9-(phenylketone)-9′-pentoxymethylfluorene, 9-(4-methylphenylketone)-9′-methoxymethylfluorene, 9-(3-methylphenylketone)-9′-methoxymethylfluorene, 9-(2-methylphenylketone)-9′-methoxymethylfluorene.

Additional examples include: 1-(ethylcarbonyl)-1′-methoxymethylcyclopentane, 1-(propylcarbonyl)-1′-methoxymethylcyclopentane, 1-(i-propylcarbonyl)-1′-methoxymethylcyclopentane, 1-(butylcarbonyl)-1′-methoxymethylcyclopentane, 1-(i-butylcarbonyl)-1′-methoxymethylcyclopentane. 1-(pentylcarbonyl)-1′-methoxymethylcyclopentane, 1-(i-pentylcarbonyl)-1′-methoxymethylcyclopentane, 1-(neopentylcarbonyl)-1′-methoxymethylcyclopentane, 1-(hexhylcarbonyl)-1 ′-methoxymethylcyclopentane, 1-(2-ethylhexylcarbonyl)-1′-methoxymethylcyclopentane, 1-(octylcarbonyl)-1′-methoxymethylcyclopentane, 1-(i-octylcarbonyl)-1′-methoxymethylcyclopentane, 1-(i-nonylcarbonyl)-1′-methoxymethylcyclopentane. 1-(ethylcarbonyl)-1′-methoxymethyl-2-methylcyclopentane, 1-(propylcarbonyl)-1′-methoxymethyl-2-methylcyclopentane, 1-(i-propylcarbonyl)-1′-methoxymethyl-2methyl-cyclopentane, 1-(butylcarbonyl)-1′-methoxymethyl-2-methylcyclopentane, 1-(i-butylcarbonyl)-1′-methoxymethyl-2-methylcyclopentane. 1-(pentylcarbonyl)-1′-methoxymethyl-2-methylcyclopentane, 1-(i-pentylcarbonyl)-1′-methoxymethyl-2-methylcyclopentane, 1-(neopentylcarbonyl)-1′-methoxymethyl-2-methylcyclopentane, 1-(hexhylcarbonyl)-1 ′-methoxymethyl-2-methylcyclopentane, 1-(2-ethylhexylcarbonyl)-1′-methoxymethyl-2-methyl cyclopentane, 1-(octylcarbonyl)-1′-methoxymethyl-2-methyl cyclopentane, 1-(i-octylcarbonyl)-1′-methoxymethyl-2-methyl cyclopentane, 1-(i-nonylcarbonyl)-1′-methoxymethyl-2-methyl cyclopentane, 1-(ethylcarbonyl)-1′-methoxymethyl-2,5-dimethylcyclopentane, 1-(propylcarbonyl)-1′-methoxymethyl-2,5-dimethylcyclopentane, 1-(i-propylcarbonyl)-1′-methoxymethyl-2,5-dimethyl-cyclopentane, 1-(butylcarbonyl)-1′-methoxymethyl-2,5-di-cyclopentane, 1-(i-butylcarbonyl)-1′-methoxymethyl-2,5-dimethylcyclopentane. 1-(pentylcarbonyl)-1′-methoxymethyl-2,5-dimethylcyclopentane, 1-(i-pentylcarbonyl)-1′-methoxymethyl-2,5-dimethylcyclopentane, 1-(neopentylcarbonyl)-1′-methoxymethyl-2,5-dimethylcyclopentane,1-(hexhylcarbonyl)-1′-methoxymethyl-2,5-dimethylcyclopentane, 1-(2-ethylhexylcarbonyl)-1′-methoxymethyl-2,5-dimethyl cyclopentane, 1-(octylcarbonyl)-1′-methoxymethyl-2,5-dimethyl cyclopentane, 1-(i-octylcarbonyl)-1′-methoxymethyl-2,5-dimethyl cyclopentane, 1-(i-nonylcarbonyl)-1′-methoxymethyl-2,5-dimethyl cyclopentane, 1-(ethylcarbonyl)-1′-methoxymethylcyclohexane, 1-(propylcarbonyl)-1′-methoxymethylcyclohexane, 1-(i-propylcarbonyl)-1′-methoxymethylcyclohexane, 1-(butylcarbonyl)-1′-methoxymethylcyclohexyl, 1-(i-butylcarbonyl)-1′-methoxymethylcyclohexane. 1-(pentylcarbonyl)-1′-methoxymethylcyclohexane, 1-(i-pentyicarbonyl)-1′-methoxymethylcyclohexane, 1-(neopentylcarbonyl)-1′-methoxymethylcyclohexane, 1-(hexhylcarbonyl)-1′-methoxymethylcyclohexane, 1-(2-ethylhexylcarbonyl)-1′-methoxymethylcyclohexane, 1-(octylcarbonyl)-1′-methoxymethylcyclohexane, 1-(i-octylcarbonyl)-1′-methoxymethylcyclohexane, 1-(i-nonylcarbonyl)-1′-methoxymethylcyclohexane. 1-(ethylcarbonyl)-1′-methoxymethyl-2-methylcyclohexane, 1-(propylcarbonyl)-1′-methoxymethyl-2-methylcyclohexane, 1-(i-propanecarbonyl)-1′-methoxymethyl-2-methyl-cyclohexane, 1-(butylcarbonyl)-1′-methoxymethyl-2-methylcyclohexane, 1-(i-butylcarbonyl)-1′-methoxymethyl-2-methylcyclohexane. 1-(pentylcarbonyl)-1′-methoxymethyl-2-methylcyclohexane, 1-(i-pentylcarbonyl)-1′-methoxymethyl-2-methylcyclohexane, 1-(neopentylcarbonyl)-1′-methoxymethyl-2-methylcyclohexane, 1-(hexhylcarbonyl)-1′-methoxymethyl-2-methylcyclohexane, 1-(2-ethylhexylcarbonyl)-1′-methoxymethyl-2-methyl cyclohexane, 1-(octylcarbonyl)-1′-methoxymethyl-2-methyl cyclohexane, 1-(i-octylcarbonyl)-1′-methoxymethyl-2-methyl cyclohexane, 1-(i-nonylcarbonyl)-1′-methoxymethyl-2-methyl cyclohexane, 1-(ethylcarbonyl)-1′-methoxymethyl-2,6-dimethylcyclohexane, 1-(propylcarbonyl)-1′-methoxymethyl-2,6-dimethylcyclohexane, 1-(i-propylcarbonyl)-1′-methoxymethyl-2,6-dimethyl-cyclohexane, 1-(butylcarbonyl)-1′-methoxymethyl-2,6-dimethyl-cyclohexane, 1-(i-butylcarbonyl)-1′-methoxymethyl-2,6-dimethylcyclohexane. 1-(pentylcarbonyl)-1′-methoxymethyl-2,6-dimethylcyclohexane, 1-(i-pentylcarbonyl)-1′-methoxymethyl-2,6-dimethylcyclohexane, 1-(neopentylcarbonyl)-1′-methoxymethyl-2,6-dimethylcyclohexane,1-(hexhylcarbonyl)-1′-methoxymethyl-2,6-dimethylcyclohexane, 1-(2-ethylhexylcarbonyl)-1′-methoxymethyl-2,6-dimethyl cyclohexane, 1-(octylcarbonyl)-1′-methoxymethyl-2,6-dimethyl cyclohexane, 1-(i-octylcarbonyl)-1′-methoxymethyl-2,6-dimethyl cyclohexane, 1-(i-nonylcarbonyl)-1′-methoxymethyl-2,6-dimethyl cyclohexane, 2,5-dimethyl-3-ethylcarbonyl-3′-methoxymethylpentane, 2,5-dimethyl-3-propylcarbonyl-3′-methoxymethylpentane, 2,5-dimethyl-3-propylcarbonyl-3′-methoxymethylpentane, 2,5-dimethyl-3-butylcarbonyl-3′-methoxymethylpentane, 2,5-dimethyl-3-i-butylcarbonyl-1′-methoxymethylcyclohexyl. 2,5-d imethyl-3-pentylcarbonyl-3′-methoxymethylpentane, 2,5-dimethyl-3-i-pentylcarbonyl-3′-methoxymethylpentane, 2,5-dimethyl-3-neopentylcarbonyl-3′-methoxymethylpentane, 2,5-dimethyl-3-hexhylcarbonyl-3′-methoxymethylpentane, 2,5-dimethyl-3-2-ethylhexylcarbonyl-3′-methoxymethylpentane, 2,5-dimethyl-3-octylcarbonyl-3′-methoxymethylpentane, 2,5-dimethyl-3-i-octylcarbonyl-3′-methoxymethylpentane, and 2,5-dimethyl-3-i-nonylcarbonyl-3′-methoxymethylpentane.

Additional useful internal electron donors include 1,8-naphthyl diaryloate compounds that have three aryl groups connected by ester linkages (three aryl groups connected by two ester linkages, such as an aryl-ester linkage-naphthyl-ester linkage-aryl compound). 1,8-naphthyl diaryolate compounds can be formed by reacting a naphthyl dialcohol compound with an aryl acid halide compound. Methods of forming an ester product through reaction of an alcohol and acid anhydride are well known in the art.

While not wishing to be bound by any theory, it is believed that the 1,8-naphthyl diaryloate compounds have a chemical structure that permits binding to both a titanium compound and a magnesium compound, both of which are typically present in a solid titanium catalyst component of an olefin polymerization catalyst system. The 1,8-naphthyl diaryloate compounds also act as internal electron donors, owing to the electron donation properties of the compounds, in a solid titanium catalyst component of an olefin polymerization catalyst system.

In one embodiment, the 1,8-naphthyl diaryloate compounds are represented by chemical Formula (III):

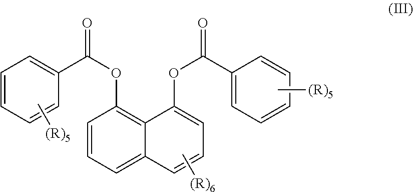

wherein each R is independently hydrogen, halogen, alkyl having 1 to about 8 carbon atoms, phenyl, arylalkyl having 7 to about 18 carbon atoms, or alkylaryl having 7 to about 18 carbon atoms. In another embodiment, each R is independently hydrogen, alkyl having 1 to about 6 carbon atoms, phenyl, arylalkyl having 7 to about 12 carbon atoms, or alkylaryl having 7 to about 12 carbon atoms.

General examples of 1,8-naphthyl diaryloate compounds include 1,8-naphthyl di(alkylbenzoates); 1,8-naphthyl di(dialkylbenzoates); 1,8-naphthyl di(trialkylbenzoates); 1,8-naphthyl di(arylbenzoates); 1,8-naphthyl di(halobenzoates); 1,8-naphthyl di(dihalobenzoates); 1,8-naphthyl di(alkylhalobenzoates); and the like.

Specific examples of 1,8-naphthyl diaryloate compounds include 1,8-naphthyl dibenzoate; 1,8-naphthyl di-4-methylbenzoate; 1,8-naphthyl di-3-methylbenzoate; 1,8-naphthyl di-2-methylbenzoate; 1,8-naphthyl di-4-ethylbenzoate; 1,8-naphthyl di-4-n-propylbenzoate; 1,8-naphthyl di-4-isopropylbenzoate; 1,8-naphthyl di-4-n-butylbenzoate; 1,8-naphthyl di-4-isobutylbenzoate; 1,8-naphthyl di-4-t-butylbenzoate; 1,8-naphthyl di-4-phenylbenzoate; 1,8-naphthyl di-4-fluorobenzoate; 1,8-naphthyl di-3-fluorobenzoate; 1,8-naphthyl di-2-fluorobenzoate; 1,8-naphthyl di-4-chlorobenzoate; 1,8-naphthyl di-3-chlorobenzoate; 1,8-naphthyl di-2-chlorobenzoate; 1,8-naphthyl di-4-bromobenzoate; 1,8-naphthyl di-3-bromobenzoate; 1,8-naphthyl di-2-bromobenzoate; 1,8-naphthyl di-4-cyclohexylbenzoate; 1,8-naphthyl di-2,3-dimethylbenzoate; 1,8-naphthyl di-2,4-dimethylbenzoate; 1,8-naphthyl di-2,5-dimethylbenzoate; 1,8-naphthyl di-2,6-dimethylbenzoate; 1,8-naphthyl di-3,4-dimethylbenzoate; 1,8-naphthyl di-3,5-dimethylbenzoate; 1,8-naphthyl di-2,3-dichlorobenzoate; 1,8-naphthyl di-2,4-dichlorobenzoate; 1,8-naphthyl di-2,5-dichlorobenzoate; 1,8-naphthyl di-2,6-dichlorobenzoate; 1,8-naphthyl di-3,4-dichlorobenzoate; 1,8-naphthyl di-3,5-dichlorobenzoate; 1,8-naphthyl di-3,5-di-t-butylbenzoate; and the like.

The internal electron donors can be used individually or in combination. In employing the internal electron donor, they do not have to be used directly as starting materials, but compounds convertible to the electron donors in the course of preparing the titanium catalyst components may also be used as the starting materials.

The solid titanium catalyst component may be formed by contacting the magnesium containing catalyst support, the titanium compound, and the optional internal electron donor by known methods used to prepare a highly active titanium catalyst component from a magnesium support, a titanium compound, and an optional electron donor.

The amounts of the ingredients used in preparing the solid titanium catalyst component may vary depending upon the method of preparation. In one embodiment, from about 0.01 to about 5 moles of the optional internal electron donor and from about 0.01 to about 500 moles of the titanium compound are used per mole of the magnesium compound used to make the solid titanium catalyst component. In another embodiment, from about 0.05 to about 2 moles of the internal electron donor and from about 0.05 to about 300 moles of the titanium compound are used per mole of the magnesium compound used to make the solid titanium catalyst component.

In one embodiment, the size (diameter) of catalyst support particles formed in accordance with the subject innovation is from about 20 μm to about 150 μm (on a 50% by volume basis). In another embodiment, the size (diameter) of catalyst support particles is from about 25 μm to about 100 μm (on a 50% by volume basis). In yet another embodiment, the size (diameter) of catalyst support particles is from about 30 μm to about 80 μm (on a 50% by volume basis).

The resulting solid titanium catalyst component generally contains a magnesium halide of a smaller crystal size than commercial magnesium halides and usually has a specific surface area of at least about 50 m²/g, such as from about 60 to 1,000 m²/g, or from about 100 to 800 m²/g. Since, the above ingredients are unified to form an integral structure of the solid titanium catalyst component, the composition of the solid titanium catalyst component does not substantially change by washing with solvents, for example, hexane.

The solid titanium catalyst component can be used after being diluted with an inorganic or organic compound such as a silicon compound or an aluminum compound. The subject innovation further relates to an olefin polymerization catalyst system containing an antistatic agent, and optionally an organoaluminum compound and/or an organosilicon compound.

The catalyst system may contain at least one organoaluminum compound in addition to the solid titanium catalyst component. Compounds having at least one aluminum-carbon bond in the molecule can be used as the organoaluminum compound. Examples of organoaluminum compounds include compounds of the following Formulae (IV) and (V).

Rₘ¹¹Al(OR¹²)ₙHₚX_{q}¹ (IV)

In Formula (IV), R¹¹ and R¹² may be identical or different, and each represent a hydrocarbon group usually having 1 to about 15 carbon atoms, preferably 1 to about 4 carbon atoms; X¹ represents a halogen atom, 0<q≧3, 0 [symbol] p≧3, 0 [symbol] <3, and m+n+p+q=3.

Organoaluminum compounds further include complex alkylated compounds between aluminum and a metal of Group I represented by Formula (V):

Mᵣ¹AlR₃₋ᵣ¹¹ (V)

wherein M¹ represents Li, Na or K, and R¹¹ is as defined above.

Examples of the organoaluminum compounds Formula (II) are as follows:

compounds of the general formula Rᵣ¹¹Al(OR¹²)₃₋ᵣ wherein R¹¹ is as defined above, and m is preferably a number represented by 1.5 [symbol] 3;

compounds of the general formula Rᵣ¹¹AIX₃₋ᵣ wherein R¹¹ is as defined above, X¹ is halogen, and m is preferably a number represented by 0<r<3;

compounds of the general formula Rᵣ¹¹AlH₃₋ᵣ wherein R¹¹ is as defined above, and m is preferably a number represented by 2 [symbol] r<3; and

compounds represented by the general formula Rₛ¹¹Al(OR¹²)ₜXᵤ¹ wherein R¹¹ and R¹² are as defined, X¹ is halogen, 0 [symbol] s≧3, 0 [symbol] t≧3, 0 [symbol] u≦3, s+t+u =3.

Specific examples of the organoaluminum compounds represented by Formula (IV) include trialkyl aluminums such as triethyl aluminum and tributyl aluminum; trialkenyl aluminums such as triisoprenyl aluminum; dialkyl aluminum alkoxides such as diethyl aluminum ethoxide and dibutyl aluminum butoxide; alkyl aluminum sesquialkoxides such as ethyl aluminum sesquiethoxide and butyl aluminum sesquibutoxide; partially alkoxylated alkyl aluminums having an average composition represented by R_{2.5}¹¹Al(OR¹²)_{0.5}; dialkyl aluminum halides such as diethyl aluminum chloride, dibutyl aluminum chloride and diethyl aluminum bromide; alkyl aluminum sesquihalides such as ethyl aluminum sesquichloride, butyl aluminum sesquichloride and ethyl aluminum sesquibromide; partially halogenated alkyl aluminums, for example alkyl aluminum dihalides such as ethyl aluminum dichloride, propyl aluminum dichloride and butyl aluminum dibromide; dialkyl aluminum hydrides such as diethyl aluminum hydride and dibutyl aluminum hydride; other partially hydrogenated alkyl aluminum, for example alkyl aluminum dihyrides such as ethyl aluminum dihydride and propyl aluminum dihydride; and partially alkoxylated and halogenated alkyl aluminums such as ethyl aluminum ethoxychloride, butyl aluminum butoxychloride and ethyl aluminum ethoxybromide.

Organoaluminum compounds further include those similar to Formula (IV) such as in which two or more aluminum atoms are bonded via an oxygen or nitrogen atom. Examples are (C₂H₅)₂AlOAl(C₂H₅)₂, (C₄H₉)₂AlOAl(C₄H₉)₂,

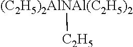

and methylaluminoxane.

Examples of organoaluminum compounds represented by Formula (V) include LiAl(C₂H₅)₄ and LiAl(C₇H₁₅)₄.

The organoaluminum compound catalyst component is used in the catalyst system of the subject innovation in an amount that the mole ratio of aluminum to titanium (from the solid catalyst component) is from about 5 to about 1,000. In another embodiment, the mole ratio of aluminum to titanium in the catalyst system is from about 10 to about 700. In yet another embodiment, the mole ratio of aluminum to titanium in the catalyst system is from about 25 to about 400.

The catalyst systems taught herein contain at least two organosilicon compounds in addition to the solid titanium catalyst component. These organosilicon compounds are termed external electron donors. The organosilicon compounds contain silicon having at least one hydrocarbon ligand.

The organosilicon compound, when used as an external electron donor serving as one component of a Ziegler-Natta catalyst system for olefin polymerization, contributes to the ability to obtain a polymer (at least a portion of which is polyolefin) having a broad molecular weight distribution and controllable crystallinity while retaining high performance with respect to catalytic activity and the yield of highly isotactic polymer.

The organosilicon compound is used in the catalyst system in an amount such that the mole ratio of the organoaluminum compound to the organosilicon compounds is from about 2 to about 90. In another embodiment, the mole ratio of the organoaluminum compound to the organosilicon compound is from about 5 to about 70. In yet another embodiment, the mole ratio of the organoaluminum compound to the organosilicon compounds is from about 7 to about 35.

In one embodiment, one of the two or more organosilicon compounds is a compound containing a nitrogen-silicon bond. In one embodiment, the compound containing a nitrogen-silicon bond has the structure of Formula (VI).

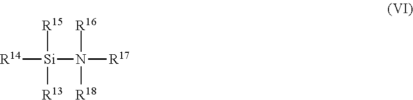

In Formula VI, R¹³, R¹⁴, and R¹⁵ are independently an alkyl, alkoxy or aryl substituent having from about 1 to about 10 carbon atoms. R¹⁶, R¹⁷, and R¹⁸ are independently an alkyl or aryl substituent having from about 1 to about 10 carbon atoms or hydrogen. In one embodiment, R¹³, R¹⁴, and R¹⁵ are the same. In another embodiment, at least two of R¹³, R¹⁴, and R¹⁵ are the same. In yet another embodiment, at least two of R¹³, R¹⁴, and R¹⁵ are different. In one embodiment, at least one of R¹⁶, R¹⁷, and R¹⁸ is hydrogen. In another embodiment, at least two of R¹⁶, R¹⁷, and R¹⁸ are the same. In one embodiment, R¹³, R¹⁴, and R¹⁵ are alkoxy substituents. In another embodiment R¹⁶, R¹⁷, and R¹⁸ are alkyl substituents. Organosilicon compounds having the structure of Formula VI can be referred to as aminosilanes.

As used herein, the terms alkyl and alkoxy refer to a substituent group that has predominantly hydrocarbon character within the context of this invention including unsaturated substituents having double or triple carbon-carbon bonds. The term “alkyl” refers to a substituent group having a carbon atom directly bonded to a silicon atom; the term “alkoxy” refers to a substituent group having an oxygen atom directly bonded to a silicon atom. These include groups that are not only purely hydrocarbon in nature (containing only carbon and hydrogen), but also groups containing substituents or hetero atoms which do not alter the predominantly hydrocarbon character of the group. Such substituents can include, but are not limited to, halo-, carbonyl-, ester-, hydroxyl-, amine-, ether-, alkoxy-, and nitro groups. These groups also may contain hetero atoms. Suitable hetero atoms will be apparent to those skilled in the art and include, for example, sulfur, nitrogen and particularly oxygen, fluorine, and chlorine. Therefore, while remaining mostly hydrocarbon in character within the context of this invention, these groups may contain atoms other than carbon present in a chain or ring otherwise composed of carbon atoms. In general, no more than about three non-hydrocarbon substituents or hetero atoms, and preferably no more than one, will be present for every five carbon atoms in any compound, group or substituent described as “hydrocarbyl” within the context of this disclosure. The terms alkyl and alkoxy expressly encompass C1-C10 alkyl and alkoxy groups such as methyl, ethyl, propyl, butyl, pentyl, hexyl, cyclopropyl, cyclobutyl, cyclopentyl, cyclohexyl t-butyl, t-butoxy, ethoxy, propyloxy, t-amyl, s-butyl, isopropyl, octyl, nonyl, methoxy, ethoxy, propoxy, butoxy, pentoxy, hexoxy, cyclopropoxy, cyclobutoxy, cyclopentoxy, and cyclohexoxy as well as any of the preceding having hydrogen substituted with hydroxyl, amine, or halo groups or atoms, where alkyl substituents have a carbon atom bonded to a Si atom and alkoxy substituents have an oxygen atom bonded to a Si atom. The term aryl expressly includes, but is not limited to, aromatic groups such as phenyl and furanyl, and aromatic groups substituted with alkyl, alkoxy, hydroxyl, amine, and/or halo groups or atoms, wherein any atom of the aryl substituent is bonded to a Si atom.

Specific examples of organosilicon compounds having a structure of Formula VI include, but are not limited to methylaminotrimethoxysilane, ethylaminotrimethoxysilane, dimethylaminotrimethoxysilane, diethylaminotrimethoxysilane, dipropylaminotrimethoxysilane, diisopropylaminotrimethoxysilane, cyclohexylmethylaminotrimethoxysilane, methylaminotriethoxysilane, ethylaminotriethoxysilane, dimethylaminotriethoxysilane, diethylaminotriethoxysilane, dipropylaminotriethoxysilane, diisopropylaminotriethoxysilane, cyclohexylmethylaminotriethoxysilane, methylaminod iethoxymethoxysilane, ethylaminodiethoxymethoxysilane, dimethylaminodiethoxymethoxysilane, diethylaminodiethoxymethoxysilane, dipropylaminodiethoxymethoxysilane, and diisopropylaminodiethoxymethoxysilane.

In one embodiment, one of the two or more organosilicon compounds is a silane having the structure of Formula VII, where R²⁰, R²¹, R²², and R²³ are, independently, an alkyl or alkoxy group as defined above.

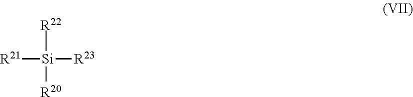

In one embodiment, at least two of R²⁰, R²¹, R²², and R²³ are alkoxy substituents. In another embodiment, at least two of R²⁰, R²¹, R²², and R²³ are alkyl substituents. In yet another embodiment, at least two of R²⁰, R²¹, R²², and R²³ are identical alkoxy substituents. In still yet another embodiment, at least two of R²⁰, R²¹, R²², and R²³ are identical alkyl substituents. Organosilicon compounds having the structure of Formula VII can be referred to as alkylsilanes.

In one embodiment, the alkyl substituents have from about 1 to about 10 carbon atoms. In another embodiment, one or more of the alkyl substituents is straight-chained. In yet another embodiment, one or more of the alkyl substituents contains a carbon atom bonded to two other carbon atoms and a silicon atom. In a further embodiment, one or more of the alkyl substituents contains a cycloalkyl group or an alkylcycloalkly. In an additional embodiment, one or more of the alkyl substituents is one or more selected from methyl, ethyl, propyl, butyl, pentyl, hexyl, cyclopropyl, cyclobutyl, cyclopentyl, cyclohexyl, and methylcylcohexyl. In a still additional embodiment, one or more of the alkyl substituents is one or more selected from an alkene and an alkyne.

Specific examples of organosilicon compounds having a structure of Formula VII include dimethyidimethoxysilane, diethyldimethoxysilane, d imethyid imethoxysilane, diethyidimethoxysilane, dipropyid imethoxysilane, diisopropyldimethoxysilane, cyclohexylmethyldimethoxysilane, dimethyldiethoxysilane, diethyldiethoxysilane, dimethyidiethoxysilane, diethyidiethoxysilane, dipropyldiethoxysilane, diisopropyidiethoxysilane, cyclohexylmethyidiethoxysilane, dimethyidiethoxypropoxysilane, diethylethoxypropoxysilane, dimethylethoxymethoxysilane, diethylethoxymethoxysilane, dipropylethoxymethoxysilane, diisopropylethoxymethoxysilane, and cyclohexylmethylethoxymethoxysilane.

In one embodiment, the mole ratio of the organosilicon compound of Formula VI to the organosilicon compound of Formula VII is from about 1:1 to about 19:1. In another embodiment, the mole ratio of the organosilicon compound of Formula VI to the organosilicon compound of Formula VII is from about 1:1 to about 4:1. In yet another embodiment, the mole ratio of the organosilicon compound of Formula VI to the organosilicon compound of Formula VII is from about 2.3:1 to about 19:1. In still yet another embodiment, the mole ratio of the organosilicon compound of Formula VI to the organosilicon compound of Formula VII is from about 4:1 to about 19:1.

The subject innovation further relates to a polymerization process which involves polymerizing or copolymerizing olefins in the presence of the polymerization catalyst system described above. The catalyst system can produce polymer product having a controlled and/or relatively large size and shape. In one embodiment, using the catalyst support, catalyst system, and/or methods of the subject innovation, the polymer product has substantially an average diameter of about 300 μm or more (on a 50% by volume basis). In another embodiment, the polymer product has an average diameter of about 1,000 μm or more (on a 50% by volume basis). In yet another embodiment, the polymer product has an average diameter of about 1,500 μm or more (on a 50% by volume basis). The relatively large size of the polymer product permits the polymer product to contain a high amount of rubber without deleteriously affecting flow properties.

Polymerization of olefins in accordance with the subject innovation is carried out in the presence of the catalyst system described above. Generally speaking, olefins are contacted with the catalyst system described above under suitable conditions to form desired polymer products. In one embodiment, preliminary polymerization described below is carried out before the main polymerization. In another embodiment, polymerization is carried out without preliminary polymerization. In yet another embodiment, the formation of impact copolymer is carried out using at least two polymerization zones.

The concentration of the solid titanium catalyst component in the preliminary polymerization is usually from about 0.01 to about 200 mM, preferably from about 0.05 to about 100 mM, calculated as titanium atoms per liter of an inert hydrocarbon medium described below. In one embodiment, the preliminary polymerization is carried out by adding an olefin and the above catalyst system ingredients to an inert hydrocarbon medium and reacting the olefin under mild conditions.

Specific examples of the inert hydrocarbon medium include aliphatic hydrocarbons such as propane, butane, pentane, hexane, heptane, octane, decane, dodecane and kerosene; alicyclic hydrocarbons such as cyclopentane, cyclohexane and methylcyclopentane; aromatic hydrocarbons such as benzene, toluene and xylene; halogenated hydrocarbons such as ethylene chloride and chlorobenzene; and mixtures thereof. In the subject innovation, a liquid olefin may be used in place of part or the whole of the inert hydrocarbon medium.

The olefin used in the preliminary polymerization can be the same as, or different from, an olefin to be used in the main polymerization.

The reaction temperature for the preliminary polymerization is sufficiently low for the resulting preliminary polymer to not substantially dissolve in the inert hydrocarbon medium. In one embodiment, the temperature is from about −20° C. to about 100° C. In another embodiment, the temperature is from about −10° C. to about 80° C. In yet another embodiment, the temperature is from about 0° C. to about 40° C.

Optionally, a molecular-weight controlling agent, such as hydrogen, may be used in the preliminary polymerization. The molecular weight controlling agent is used in such an amount that the polymer obtained by the preliminary polymerization has an intrinsic viscosity, measured in decalin at 135° C., of at least about 0.2 dl/g, and preferably from about 0.5 to 10 dl/g.

In one embodiment, the preliminary polymerization is desirably carried out so that from about 0.1 g to about 1,000 g of a polymer forms per gram of the titanium catalyst component of the catalyst system. In another embodiment, the preliminary polymerization is desirably carried out so that from about 0.3 g to about 500 g of a polymer forms per gram of the titanium catalyst component. If the amount of the polymer formed by the preliminary polymerization is too large, the efficiency of producing the olefin polymer in the main polymerization may sometimes decrease, and when the resulting olefin polymer is molded into a film or another article, fish eyes tend to occur in the molded article. The preliminary polymerization may be carried out batchwise or continuously.

After the preliminary polymerization conducted as above, or without performing any preliminary polymerization, the main polymerization of an olefin is carried out in the presence of the above-described olefin polymerization catalyst system formed from the solid titanium catalyst component containing the organoaluminum compound and the organosilicon compounds (external electron donors).

Examples of olefins that can be used in the main polymerization are alpha-olefins having 2 to 20 carbon atoms such as ethylene, propylene, 1-butene, 4-methyl-1-pentene, 1-pentene, 1-octene, 1-hexene, 3-methyl-1-pentene, 3-methyl-1-butene, 1-decene, 1-tetradecene, 1-eicosene, and vinylcyclohexane. In the process of the subject innovation, these alpha-olefins may be used individually or in any combination.

In one embodiment, propylene or 1-butene is homopolymerized, or a mixed olefin containing propylene or 1-butene as a main component is copolymerized. When the mixed olefin is used, the proportion of propylene or 1-butene as the main component is usually at least about 50 mole %, preferably at least about 70 mole %.

By performing the preliminary polymerization, the catalyst system in the main polymerization can be adjusted in the degree of activity. This adjustment tends to result in a polymer powder having good morphology and a high bulk density. Furthermore, when the preliminary polymerization is carried out, the particle shape of the resulting polymer becomes more rounded or spherical. In the case of slurry polymerization, the slurry attains excellent characteristics while in the case of gas phase polymerization, the catalyst bed attains excellent characteristics. Furthermore, in these embodiments, a polymer having a high isotacticity index can be produced with a high catalytic efficiency by polymerizing an alpha-olefin having at least about 3 carbon atoms. Accordingly, when producing the propylene copolymer, the resulting copolymer powder or the copolymer becomes easy to handle.

In the homopolymerization or copolymerization of these olefins, a polyunsaturated compound such as a conjugated diene or a non-conjugated diene may be used as a comonomer. Examples of comonomers include styrene, butadiene, acrylonitrile, acrylamide, alpha-methyl styrene, chlorostyrene, vinyl toluene, divinyl benzene, diallylphthalate, alkyl methacrylates and alkyl acrylates. In one embodiment, the comonomers include thermoplastic and elastomeric monomers.

In the process of the subject innovation, the main polymerization of an olefin is carried out usually in the gaseous or liquid phase.

In one embodiment, polymerization (main polymerization) employs a catalyst system containing the titanium catalyst component in an amount from about 0.001 to about 0.75 mmol calculated as Ti atom per liter of the volume of the polymerization zone, the organoaluminum compound in an amount from about 1 to about 2,000 moles per mole of titanium atoms in the titanium catalyst component, and the organosilicon compounds (external donors) in an amount from about 0.001 to about 10 moles calculated as Si atoms in the organosilicon compounds per mol of the metal atoms in the organoaluminum compound. In another embodiment, polymerization employs a catalyst system containing the titanium catalyst component in an amount from about 0.005 to about 0.5 mmol calculated as Ti atom per liter of the volume of the polymerization zone, the organoaluminum compound in an amount from about 5 to about 500 moles per mole of titanium atoms in the titanium catalyst component, and the organosilicon compounds (external donors) in an amount from about 0.01 to about 2 moles calculated as Si atoms in the organosilicon compounds per mol of the metal atoms in the organoaluminum compound. In yet another embodiment, polymerization employs a catalyst system containing the organosilicon compounds (external donors) in an amount from about 0.05 to about 1 mole calculated as Si atoms in the organosilicon compound per mol of the metal atoms in the organoaluminum compound.

When the organoaluminum compound and the organosilicon compound are used partially in the preliminary polymerization, the catalyst system subjected to the preliminary polymerization is used together with the remainder of the catalyst system components. The catalyst system subjected to the preliminary polymerization may contain the preliminary polymerization product.

The use of hydrogen at the time of polymerization promotes and contributes to control of the molecular weight of the resulting polymer, and the polymer obtained may have a high melt flow rate. In this case, the isotacticity index of the resulting polymer and the activity of the catalyst system are increased according to the methods of the subject innovation.

In one embodiment, the polymerization temperature is from about 20° C. to about 200° C. In another embodiment, the polymerization temperature is from about 50° C. to about 180° C. In one embodiment, the polymerization pressure is typically from about atmospheric pressure to about 100 kg/cm². In another embodiment, the polymerization pressure is typically from about 2 kg/cm² to about 50 kg/cm². The main polymerization may be carried out batchwise, semi-continuously or continuously. The polymerization may also be carried out in two or more stages under different reaction conditions.

The olefin polymer so obtained may be a homopolymer, a random copolymer, a block copolymer or an impact copolymer. The impact copolymer contains an intimate mixture of a polyolefin homopolymer and a polyolefin rubber. Examples of polyolefin rubbers include ethylene propylene rubbers (EPR) such as ethylene propylene monomer copolymer rubber (EPM) and ethylene propylene diene monomer terpolymer rubber (EPDM).

The olefin polymer obtained by using the catalyst system has a very small amount of an amorphous polymer component and therefore a small amount of a hydrocarbon-soluble component. Accordingly, a film molded from this resultant polymer has low surface tackiness.

The polyolefin obtained by the polymerization process is excellent in particle size distribution, particle diameter and bulk density, and the copolyolefin obtained has a narrow composition distribution. In an impact copolymer, excellent fluidity, low temperature resistance, and a desired balance between stiffness and elasticity can be obtained.

In one embodiment, propylene and an alpha-olefin having 2 or from about 4 to about 20 carbon atoms are copolymerized in the presence of the catalyst system described above. The catalyst system may be one subjected to the preliminary polymerization described above. In another embodiment, propylene and an ethylene rubber are formed in two reactors coupled in series to form an impact copolymer.

The alpha-olefin having 2 carbon atoms is ethylene, and examples of the alpha-olefins having about 4 to about 20 carbon atoms are 1-butene, 1-pentene, 4-methyl-1-pentene, 1-octene, 1-hexene, 3-methyl-1-pentene, 3-methyl-1-butene, 1-decene, vinylcyclohexane, 1-tetradecene, and the like.

In the main polymerization, propylene may be copolymerized with two or more such alpha-olefins. For example, it is possible to copolymerize propylene with ethylene and 1-butene. In one embodiment, propylene is copolymerized with ethylene, 1-butene, or ethylene and 1-butene.

Block copolymerization of propylene and another alpha-olefin can be carried out in two stages. The polymerization in a first stage can be the homopolymerization of propylene or the copolymerization of propylene with the other alpha-olefin. In one embodiment, the amount of the monomers polymerized in the first stage is from about 50 to about 95% by weight. In another embodiment, the amount of the monomers polymerized in the first stage is from about 60 to about 90% by weight. In the subject innovation, this first stage polymerization can, as required, be carried out in two or more stages under the same or different polymerization conditions.

In one embodiment, the polymerization in a second stage is desirably carried out such that the mole ratio of propylene to the other alpha-olefin(s) is from about 10/90 to about 90/10. In another embodiment, the polymerization in a second stage is desirably carried out such that the mole ratio of propylene to the other alpha-olefin(s) is from about 20/80 to about 80/20. In yet another embodiment, the polymerization in a second stage is desirably carried out such that the mole ratio of propylene to the other alpha-olefin(s) is from about 30/70 to about 70/30. Producing a crystalline polymer or copolymer of another alpha-olefin may be provided in the second polymerization stage.

The propylene copolymer so obtained may be a random copolymer or the above-described block copolymer. This propylene copolymer typically contains from about 7 to about 50 mole % of units derived from the alpha-olefin having 2 or from about 4 to about 20 carbon atoms. In one embodiment, a propylene random copolymer contains from about 7 to about 20 mole % of units derived from the alpha-olefin having 2 or from about 4 to about 20 carbon atoms. In another embodiment, the propylene block copolymer contains from about 10 to about 50 mole % of units derived from the alpha-olefin having 2 or 4-20 carbon atoms.

In another one embodiment, copolymers made with the catalyst system contain from about 50% to about 99% by weight poly-alpha-olefins and from about 1% to about 50% by weight comonomers (such as thermoplastic or elastomeric monomers). In another embodiment, copolymers made with the catalyst system contain from about 75% to about 98% by weight poly-alpha-olefins and from about 2% to about 25% by weight comonomers.

It should be understood that where there is no reference to the polyunsaturated compound that can be used, the method of polymerization, the amount of the catalyst system and the polymerization conditions, the same description as the above embodiments are applicable.

The catalysts/methods of the subject innovation can in some instances lead to the production of poly-alpha-olefins including ICPs having xylene solubles (XS) from about 0.5% to about 10%. In another embodiment, poly-alpha-olefins having xylene solubles (XS) from about 1% to about 6% are produced in accordance with the subject innovation. In yet another embodiment, poly-alpha-olefins having xylene solubles (XS) from about 2% to about 5% are produced in accordance with the subject innovation. XS refers to the percent of solid polymer that dissolves into xylene. A low XS % value generally corresponds to a highly isotactic polymer (i.e., higher crystallinity), whereas a high XS % value generally corresponds to a low isotactic polymer.

In one embodiment, the catalyst efficiency (measured as kilogram of polymer produced per gram of catalyst per hour) of the catalyst system of the subject innovation is at least about 10. In another embodiment, the catalyst efficiency of the catalyst system of the subject innovation is at least about 30. In yet another embodiment, the catalyst efficiency of the catalyst system of the subject innovation is at least about 50.

The catalysts/methods of the subject innovation can in some instances lead to the production of polyolefins including having melt flow rate (MFR) from about 5 to about 250 g (10 min)⁻¹. The MFR is measured according to ASTM standard D 1238.

MFR for synthesized polymers increases as the amount of hydrogen increases (mole percent of hydrogen). Hydrogen response can be related to the mean slope or mean value of a derivative of a plot of hydrogen amount versus MFR of an olefin polymer formed over a functional range of hydrogen concentration. One aspect of this invention relates to combining a first organosilicon compound having a high response as measured by change in MFR as the mole percent of hydrogen varies with a second organosilicon compound with a lower hydrogen response and higher activity than the first organosilicon compound and high isotacticity (greater than 97% mmmm pentads with common stereocenter), when employed individually. In one embodiment, the hydrogen response of the first organosilicon compound is about 25% or more higher than the hydrogen response of the second organosilicon compound. In another embodiment, the hydrogen response of the first organosilicon compound is about 50% or more higher than the hydrogen response of the second organosilicon compound. In yet another embodiment, the hydrogen response of the first organosilicon compound is about 100% or more higher than the hydrogen response of the second organosilicon compound. In one embodiment, the highest activity of the second organosilicon compound observed over a functional range of hydrogen concentration is about 25% or more higher than the highest activity of the first organosilicon compound observed over a functional range of hydrogen concentration. In another embodiment, the highest activity of the second organosilicon compound observed over a functional range of hydrogen concentration is about 50% or more higher than the highest activity of the first organosilicon compound observed over a functional range of hydrogen concentration. In another embodiment, the highest activity of the second organosilicon compound observed over a functional range of hydrogen concentration is about 200% or more higher than the highest activity of the first organosilicon compound observed over a functional range of hydrogen concentration.

The catalysts/methods of the subject innovation lead to the production having a relatively narrow molecular weight distribution. In one embodiment, the Mw/Mn of a polypropylene polymer made with the subject catalyst system is from about 2 to about 6. In another embodiment, the Mw/Mn of a polypropylene polymer made with the subject catalyst system is from about 3 to about 5.

The following examples illustrate the subject innovation. Unless otherwise indicated in the following examples and elsewhere in the specification and claims, all parts and percentages are by weight, all temperatures are in degrees Centigrade, and pressure is at or near atmospheric pressure.

### EXAMPLES

A commercially available catalyst, Lynx 1000 (BASF Corp., Florham Park, N.J.), was employed for all polymerization trials reported herein. Lynx 1000 catalyst contains approximately 1.6% by weight of Ti and 19.9% by weight of Mg; the catalyst is supplied as a slurry in mineral oil containing 23.0% by weight of the solid catalyst. Ziegler-Natta catalysts are sensitive to air and procedures must be observed to avoid exposure to oxygen. The external electron donors are added to the other components of the catalyst immediately prior to performance of the polymerization.

The catalyst charging procedure is designed such that the amount of mineral oil or other liquid comprising the catalyst slurry (i.e, hexane or other non-polar organic solvent) has minimal impact on the polymerization. The catalyst, supplied as a mineral oil slurry, is diluted with hexane in a glass vessel with a Teflon® stopcock, where the stopcock has an inlet to allow a continuous purge with nitrogen gas. The glass vessel serves as a catalyst charging device.

First, 1.5 ml of 25% triethyl aluminum (TEA) in hexane or similar non-polar solvent is injected into a 2 liter reactor at 55° C., which is free from air and moisture by a nitrogen purge. Second, the external donor is added to the 2 liter reactor. The donor is diluted with hexane in a glass vessel purged with nitrogen and designed to avoid contamination with oxygen and water. The precise amount of dilution of the external donors is not critical provided that the external donors are well dissolved. The external donors are then added to the 2 liter reactor with either a syringe or a micropipete under a nitrogen blanket. The two external donors can be added to the glass vessel, diluted and added to the reactor separately in order to minimize the time for interaction between the two separate external donors prior to their interaction with TEA. N-diethylaminotriethoxysilane is added to the reactor prior to diisopropyldimethoxysilane. Third, the Ti-containing catalyst is added to the 2 L reactor. 6.5 mg of Ti-containing catalyst in mineral oil (0.0301 mL) is added to the glass vessel with a Teflon® stopcock using a micropipette under a nitrogen blanket and then pushed into the 2L reactor with a 45 g propylene stream. The total propylene dose charged to the polymerization reactor is 140 g inclusive of the 45 g or other amount of propylene used to push the Ti-containing catalyst into the reactor.

Hydrogen gas is charged into the reactor by a continuous feed to achieve a constant GC hydrogen response over the whole polymerization time; the value of H₂-GC is reported as an average mole percentage. At the point the Ti solid catalyst component, organoaluminum compound and external donors are introduced to the reactor, prepolymerization occurs in the condensed liquid phase. The temperature in the reactor is raised past the vaporization point of the propylene monomer from about 8 to about 15 minutes after introduction of the catalyst system and olefin monomer into the reactor. The polymerization of propylene proceeds for 2 hours at 80° C. at a pressure of about 3.0 Mpa. At the end of polymerization, the reactor is cooled down to 20° C. The polypropylene is completely dried in a vacuum oven.

The characteristics of polymer product and process of making are summarized in Table 1 for the various polymerization trials. The type of external donor used is indicated where a mixture is indicated by mole percent of the total moles of external donor used. For example, if 1 mmol of total external donor is used, the ratio of 80:20 indicates that 0.8 mmol of the first external donor was added followed by 0.2 mmol of the second external donor. Example 1 is 90:10/U-donor:P-donor and Example 2 is 80:20/U-donor:P-donor. Comparative Example 1 employs U-donor; Comparative Example 2 employs P-donor; and Comparative Example 3 employs C-donor. MFR refers to melt flow index, XS refers to xylene solubles, and D refers to an average diameter of polymer product on a 50% by volume basis as determined by a Malvern Instrument. U-donor is N-d iethylaminotriethoxysilane; P-donor is d iisopropyldimethoxysilane (Dl PDMS); C-donor is cyclohexylmethyldimethoxysilane. D indicates the total amount of external donor added. The properties of high hydrogen response with improved activity can be obtained by combining U-donor with any alkylsilane exhibiting high activity and high isotacticity including combinations of U-donor and C-donor. Typically, it is only necessary to replace about 5% of U-donor used as an external electron catalyst (a ratio of U-donor to alkylsilane of greater than about 19:1) to achieve the benefit of high hydrogen response and high activity.

TABLE 1
Polymerization in 2 L reactor (experimental data)
Lynx 1000 ST (320307071) Conditions Polymerization 120 min at 80° C., 3.0 MPa in gas phase Order of components charging:
TEA, ext. donor (at 40° C.; 0.1 MPa N2), hydrogen (at 0.8 MPa); Catalyst charged into the pressurized reactor (2.1 MPa, 55° C.)

| | | | | | | | | | | | | | | | |
|---|---|---|---|---|---|---|---|---|---|---|---|---|---|---|---|
| | | | | | | | | Net | | | | | | | MFR/H2 |
| | | | | | | H2-GC | | activity | H2 | | | MFR | Bulk | | g/10 min |
| | Cat. | TEA | D | | | (avg) | Total | kg/(g- | cons. | H2/Yied | MFR/ | 21N | Dens. | X.S. | per mol |
| Ref. No. | mg | mmol | umol | TEA/Ti | D/Ti | mol % | yield g | cat * h) | mmol | umol/g | H2/Yied | g/10 min | g/L | % | % H2 |

Comparative Example 1

| | | | | | | | | | | | | | | | |
|---|---|---|---|---|---|---|---|---|---|---|---|---|---|---|---|
| H0924G2C | 6.5 | 0.25 | 23 | 116 | 10.6 | 0.35 | 222 | 17 | 9.8 | 43.9 | 0.408 | 17.9 | 478 | 1.2 | 51.1 |
| H0910G2C | 6.5 | 0.25 | 23 | 116 | 10.6 | 0.65 | 254 | 19.5 | 12.3 | 48.3 | 0.598 | 28.9 | 467 | 0.9 | 44.5 |
| H0927G2C | 6.5 | 0.25 | 23 | 116 | 10.6 | 1.18 | 275 | 21.1 | 20 | 72.6 | 0.843 | 61.2 | 471 | 1.1 | 51.9 |
| H0935G2C | 6.5 | 0.25 | 22.7 | 116 | 10.4 | 1.63 | 274 | 21 | 24.1 | 88.2 | 1.079 | 95.1 | 470 | 1.1 | 58.3 |
| H0942G2C | 6.5 | 0.25 | 22.7 | 116 | 10.4 | 2.44 | 271 | 20.8 | 26.1 | 96.2 | 1.754 | 168.7 | 462 | 1.1 | 69.1 |
| H0947G2C | 6.5 | 0.25 | 22.7 | 116 | 10.4 | 3.09 | 281 | 21.5 | 31.7 | 112.8 | 2.051 | 231.5 | 477 | 1.3 | 74.9 |

Example 1 (90:10)

| | | | | | | | | | | | | | | | |
|---|---|---|---|---|---|---|---|---|---|---|---|---|---|---|---|
| H0933G2C | 6.5 | 0.25 | 20.2 | 116 | 10.3 | 0.53 | 319 | 24.5 | 12.6 | 39.3 | 0.249 | 9.8 | 474 | 0.9 | 18.5 |
| H0931G2C | 6.5 | 0.25 | 20.2 | 116 | 10.3 | 1.08 | 411 | 31.3 | 20.8 | 50.7 | 0.52 | 26.4 | 469 | 1 | 24.4 |
| H0945G2C | 6.5 | 0.25 | 20.2 | 116 | 10.3 | 1.91 | 333 | 25.6 | 28 | 84 | 0.736 | 61.8 | 460 | 1.2 | 32.4 |
| H0938G2C | 6.5 | 0.25 | 20.2 | 116 | 10.3 | 1.89 | 329 | 25.2 | 23.8 | 72.2 | 0.763 | 55.1 | 465 | 1.2 | 29.2 |
| H0943G2C | 6.5 | 0.25 | 20.2 | 116 | 10.3 | 2.62 | 306 | 23.3 | 31.1 | 101.5 | 1.076 | 109.2 | 461 | 1.2 | 41.7 |
| H0949G2C | 6.5 | 0.25 | 20.2 | 116 | 10.3 | 4.09 | 304 | 23.3 | 35 | 115.2 | 1.843 | 212.4 | 458 | 1.5 | 51.9 |

Example 2 (80:20)

| | | | | | | | | | | | | | | | |
|---|---|---|---|---|---|---|---|---|---|---|---|---|---|---|---|
| H0934G2C | 6.5 | 0.25 | 17.6 | 116 | 10.3 | 0.59 | 390 | 29.9 | 15.1 | 38.7 | 0.22 | 8.5 | 469 | 0.9 | 14.4 |
| H0932G2C | 6.5 | 0.25 | 17.6 | 116 | 10.3 | 1.27 | 340 | 26 | 18.3 | 53.8 | 0.34 | 18.3 | 468 | 1.1 | 14.4 |
| H0937G2C | 6.5 | 0.25 | 17.6 | 116 | 10.3 | 1.91 | 345 | 26.4 | 24.9 | 72.3 | 0.76 | 54.9 | 463 | 1 | 28.7 |
| H0951G2C | 6.5 | 0.25 | 18 | 116 | 10.3 | 2.58 | 312 | 23.9 | 32.5 | 104.1 | 0.576 | 60 | 456 | 1.8 | 23.3 |
| H0939G2C | 6.5 | 0.25 | 17.6 | 116 | 10.3 | 2.63 | 331 | 25.4 | 37.8 | 114.1 | 1.209 | 138 | 464 | 1.4 | 52.5 |
| H0950G2C | 6.5 | 0.25 | 18 | 116 | 10.3 | 4.18 | 337 | 25.7 | 37.9 | 112.4 | 1.731 | 194.5 | 458 | 1.6 | 46.5 |

Comparative Example 2

| | | | | | | | | | | | | | | | |
|---|---|---|---|---|---|---|---|---|---|---|---|---|---|---|---|
| H0936G2X | 6.5 | 0.25 | 22.7 | 116 | 10.4 | 1.44 | 426 | 32.6 | 22 | 51.7 | 0.325 | 16.8 | 464 | 0.9 | 11.7 |
| H0925G2C | 6.5 | 0.25 | 22.7 | 116 | 10.4 | 1.65 | 412 | 31.4 | 23.4 | 56.7 | 0.36 | 20.4 | 465 | 0.8 | 12.4 |
| H0923G2C | 6.5 | 0.25 | 22.7 | 116 | 10.4 | 2.19 | 407 | 31.1 | 30.3 | 74.3 | 0.405 | 30.1 | 458 | 0.8 | 13.7 |
| H0928G2C | 6.5 | 0.25 | 22.7 | 116 | 10.4 | 3.59 | 326 | 24.9 | 28.8 | 88.2 | 0.66 | 58.2 | 450 | 0.9 | 16.2 |
| H0940G2C | 6.5 | 0.25 | 22.7 | 116 | 10.4 | 5.58 | 275 | 21.1 | 31.2 | 113.4 | 1.108 | 125.6 | 450 | 1.6 | 22.5 |
| H0944G2C | 6.5 | 0.25 | 22.7 | 116 | 10.4 | 7.6 | 279 | 21.4 | 50.8 | 182.5 | 1.338 | 244.1 | 445 | 1.5 | 32.1 |

Comparative Example 3

| | | | | | | | | | | | | | | | |
|---|---|---|---|---|---|---|---|---|---|---|---|---|---|---|---|
| H0926G2C | 6.5 | 0.25 | 22.8 | 116 | 10.5 | 0.99 | 363 | 27.8 | 11.7 | 32.3 | 0.631 | 20.4 | 463 | 1 | 20.6 |
| H0894G2C | 6.5 | 0.25 | 22.8 | 116 | 10.5 | 1.58 | 354 | 27.2 | 15.4 | 43.7 | 0.703 | 30.7 | 459 | 1 | 19.4 |
| H0929G2C | 6.5 | 0.25 | 24.3 | 116 | 11.2 | 2.84 | 359 | 27.5 | 21.1 | 58.7 | 0.918 | 53.9 | 454 | 1.2 | 19.0 |
| H0941G2C | 6.5 | 0.25 | 24.3 | 116 | 11.2 | 4.63 | 254 | 19.4 | 20.6 | 81.4 | 0.962 | 78.3 | 453 | 1.7 | 16.9 |
| H0946G2C | 6.5 | 0.25 | 24.3 | 116 | 11.2 | 6.48 | 294 | 22.5 | 35.5 | 120.7 | 1.185 | 143.1 | 457 | 1.5 | 22.1 |
| H0948G2C | 6.5 | 0.25 | 24.3 | 116 | 11.2 | 8.95 | 236 | 18.2 | 38.7 | 163.9 | 1.298 | 212.8 | 449 | 1.7 | 23.8 |

The data reported in Table 1 demonstrates that a mixture of U-donor and P-donor (Examples 1 and 2) surprisingly has properties superior to either of U-donor or P-donor (Comparative Examples 1 and 2) used individually. Further, the catalytic properties of the mixtures of Examples 1 and 2 do not have properties that represent a weighted average of individual properties. The trials using Comparative Example 1 have an excellent hydrogen response. Using U-donor as the only external electron donor, MFR increases from 17.9 to 231.5 g 10 min⁻¹ over the range of 0.35 to 3.09 mol. % hydrogen gas. However, overall activity of the catalyst of Comparative Example 1 is low over the entire range of 0.35 to 3.09 mol. % hydrogen gas with values from 17 to 21.5 kg/(g-cat*hr). It is noted that in Comparative Example 2, the activity increases as the mole fraction of hydrogen increases while in Comparative Example 1 the activity peaks and then decreases as the mole fraction of hydrogen increases.

Comparative Example 2 exhibits a significantly lower hydrogen response compared to Comparative Example 1. Comparative Example 2 requires a hydrogen mole fraction of 7.6% to reach an MFR of 244.1 g (10 min)⁻¹ whereas Comparative Example 1 only requires a hydrogen mole fraction of 3.09% to reach a comparable MFR level of 231.5 g (10 min)⁻¹. That is, the hydrogen response of Comparative Example 2 is less than half of the hydrogen response for Comparative Example 1. However, Comparative Example 2 has higher net catalytic activity at the lower end of the range of hydrogen mole fraction employed in the trials, for example, 31.4 kg/(g-cat*hr) for a hydrogen mole percentage of 1.65 or 2.19% compared to a maximum observed catalytic activity of 21.5 kg/(g-cat*hr) for Comparative Example 1. It is noted that with Comparative Example 2 the net catalytic activity decreases as the mole percentage of hydrogen increases.

As will be discussed in greater detail below, the data reported in Table 1 demonstrates that including a small amount of P-donor in conjunction with U-donor yields a catalytic system with a hydrogen response profile about comparable to U-donor (Comparative Example 1) used individually with greatly improved net catalytic activity. For Example 1, maximum activity is observed using a hydrogen mol. % of 1.08 with a net activity of 31.3 kg_{polymer}/(g_{cat}*hr). If the system were to behave as a simple weighted average of a catalyst employing U-donor (Comparative Example 1) and a catalyst employing P-donor (Comparative Example 2), the predicted net activity of the Example 1 system at 1.08 mol. % would be estimated to be approximately the sum of 0.9×21.1 kg_{polymer}/(g_{cat}*hr) (U-donor activity at 1.18 mol. % H₂) and 0.1×32.6 kg_{polymer}/(g_{cat}*hr) (P-donor activity at 1.44 mol. % H₂), or 22.3 kg/(g-cat*hr). The actual observed net catalytic activity is 31.3 kg_{polymer}/(g_{cat}*hr) far above the predicted activity. That is, including P-donor as a minor constituent with the balance of electron donor added being U-donor yields a system wherein the net catalytic activity is comparable to a system using 100% P-donor (Comparative Example 2).

Even more remarkable is that including P-donor as a minor constituent of the external donor in conjunction with U-donor yields a hydrogen response superior to that of P-donor (Comparative Example 2) used alone. For example, at a hydrogen mole fraction of 1.89% the Example 1 system yields an MFR of 55.1 g (10 min)⁻¹ while P-donor used alone (Comparative Example 2) only yields an MFR of 30.1 g*(10 min)⁻¹ using a comparable hydrogen mole percentage of 2.19%.

The innovations disclosed herein are particularly directed to Ziegler-Natta catalysts having excellent hydrogen response while maintaining net catalytic activity at a level suitable for commercial use. In one embodiment, a catalytic activity suitable for commercial use is a net catalytic activity of about 20 kg_{polymer}/(g_{cat}*hr) at a pressure of about 3.0 Mpa or less. In another embodiment, a catalytic activity suitable for commercial use is a net catalytic activity of about 25 kg_{polymer}/(g_{cat}*hr) at a pressure of about 3.0 Mpa. In yet another embodiment, a catalytic activity suitable for commercial use is a net catalytic activity of about 30 kg_{polymer}/(g_{cat}*hr) at a pressure of about 3.0 Mpa or less. Those skilled in the art will readily recognize that catalyze reactions proceed at a rate that is dependent upon the concentration of reactant species.

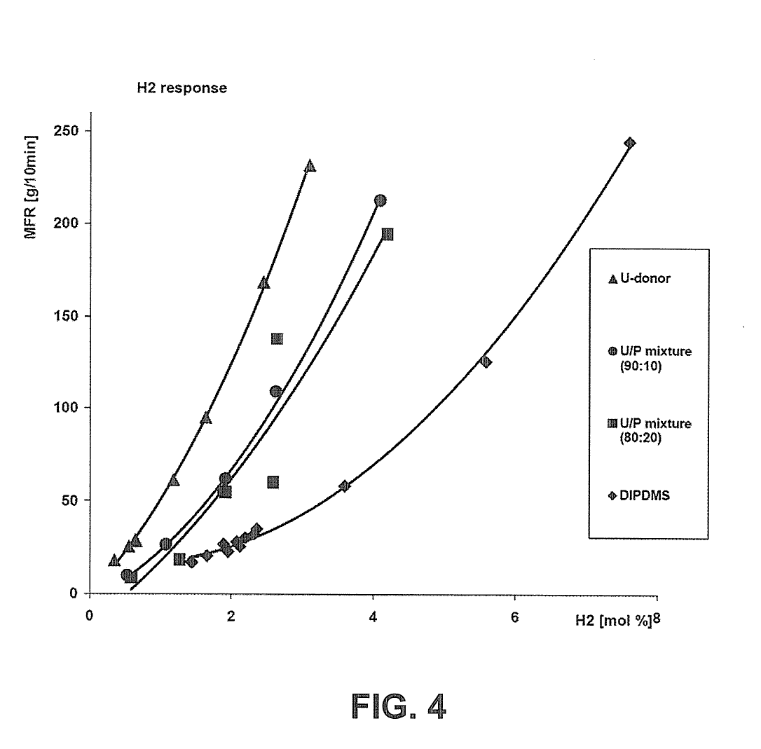

To illustrate the hydrogen response properties of the catalysts described herein, the hydrogen response for the Examples shown in Table 1 is presented in the Graph of FIG. 4. As can be observed in FIG. 4, the hydrogen response (increase in MFR versus hydrogen mole percent) for U-donor used alone is several-fold higher than P-donor used alone. For U-donor used in conjunction with a minor amount of P-donor, the hydrogen response is intermediate between U-donor and P-donor used alone; however, hydrogen response is at an acceptable level and, as explained in Table 1, the catalytic activities of Examples 1 and 2 are at levels suitable for commercial use over the entire reported range of hydrogen mole percent and MFR of olefin polymer produced.

Those skilled in the art will readily understand that the exact magnitude of net catalytic activity and hydrogen response depends upon the exact pairing of Ti solid catalyst component, organoaluminum component and external electron donor combination. The hydrogen response for a polymerization reaction proceeding at any mole percent of hydrogen can be described by the ratio between MFR expressed in units of g (10 min)⁻¹ and mole percent of hydrogen in the expressed in percent units. In one embodiment, the ratio of MFR expressed in units of g (10 min)⁻¹ to the mole percentage of hydrogen expressed in percent units is greater than about 14:1 when the mole percent of hydrogen is from about 0.2 to about 2%, the ratio of MFR expressed in units of g (10 min)⁻¹ to the mole percentage of hydrogen expressed in percent units is greater than about 25:1 when the mole percent of hydrogen is from about 2 to about 3%, and the ratio of MFR expressed in units of g (10 min)⁻¹ to the mole percentage of hydrogen expressed in percent units is greater than about 35:1 when the mole percent of hydrogen is from about 3 to about 6%. In another embodiment, the ratio of MFR expressed in units of g (10 min)⁻¹ to the mole percentage of hydrogen expressed in percent units is from about 14:1 to about 40:1 when the mole percent of hydrogen is from about 0.2 to about 2%, the ratio of MFR expressed in units of g (10 min)⁻¹ to the mole percentage of hydrogen expressed in percent units is from about 25:1 to about 60:1 when the mole percent of hydrogen is from about 2 to about 3%, and the ratio of MFR expressed in units of g (10 min)⁻¹ to the mole percentage of hydrogen expressed in percent units is from 40:1 to about 70:1 when the mole percent of hydrogen is from about 3 to about 6%.

In one embodiment, the MFR of the olefin polymer produced by the catalytic system increases by a factor of at least about 2 over a range of hydrogen mole percent from about 0.5 to about 1%. In another embodiment, the MFR of the olefin polymer produced by the catalytic system increases by a factor of at least about 2 over a range of hydrogen mole percent from about 1 to about 2%. In yet another embodiment, the MFR of the olefin produced by the catalytic system increases by a factor of at least about 3 over a range of hydrogen mole percent from about 2 to about 4%.

In one embodiment, the MFR of a polypropylene polymer produced by the catalytic system is from about 15 to about 30 g (10 min)⁻¹ at an average hydrogen mole percentage of about 1%. In another embodiment, the MFR of a polypropylene polymer produced by the catalytic system is from about 25 to about 30 g (10 min)⁻¹ at an average hydrogen mole percentage of about 1%. In yet another embodiment, the MFR of a polypropylene polymer produced by the catalytic system is from about 45 to about 70 g (10 min)⁻¹ at an average hydrogen mole percent of about 2%. In still yet another embodiment, the MFR of a polypropylene polymer produced by the catalytic system is from about 50 to about 65 g (10 min)⁻¹ at an average hydrogen mole percent of about 2%. In a further embodiment, the MFR of a polypropylene polymer produced by the catalytic system is greater than about 120 g (10 min)⁻¹ at an average hydrogen mole percentage of about 3.5%. In a further embodiment, the MFR of a polypropylene polymer produced by the catalytic system is greater than about 140 g (10 min)⁻¹ at an average hydrogen mole percent of about 3.5.

The advantageous catalytic properties described herein can be achieved by employing a Ziegler-Natta catalyst employing at least two external electron donors, wherein each of the at least two external electron donors used individually with the Ziegler-Natta have a hydrogen response within a specified range of the other external electron donor. That is, each of the at least two external electron donors is selected based upon their performance when used individually in polymerizing olefin monomers relative to the other external electron donor used individually under identical reaction conditions. As described above, the mole ratio of the at least two external electron donors can range from about 1:1 to about 19:1, or other ranges as recited above, where the ratios are expressed as a molar amount of the first external electron donor:molar amount of the second external electron donor.

The first electron donor when used individually as a component of a reference system produces a polyolefin having a melt flow rate of MFR(1). The second electron donor when used individually as a component of a reference system produces a polyolefin having a melt flow rate of MFR(2). The term “reference system,” as used herein and in the appended claims, refers to a set of known components, reagents, and conditions for production a polyolefin useful for comparing the performance of different external electron donors under substantially identical conditions. That is, a “reference system” functions to directly compare the hydrogen response of a first electron donor with a second electron donor using a substantially identical catalyst reagents, polyolefin reagents, and reaction conditions. A reference system encompasses an organo-aluminum compound, a solid Ti catalyst component, and an olefin or olefins.

The values of MFR(1) and MFR(2) are determined through use of either the first external electron donor or the second external electron donor, respectively, in combination with the reference system. That is, an olefin is polymerized into a polyolefin using the reference system combined with either the first external electron donor or the second external electron donor has an MFR of MFR(1) or MFR(2), respectively, for a particular average mole percent of hydrogen gas. The first and second external electron donors are selected such that MFR(1) and MFR(2) have values such that 0.5≦log [MFR(1)/MFR(2)]≦0.8, where the mole fraction of hydrogen is from about 1 to about 10 mole percent hydrogen gas in the polymerization reaction. In another embodiment, the relationship between MFR(1) and MFR(2) satisfies the relationship when the average mole fraction of hydrogen is from about 1 to about 5 mole percent. Table 2 shows the MFR of polypropylene produced by a Ziegler-Natta catalyst system employing either U-donor (first external electron donor) or P-donor (second external electron donor) as an external electron donor. As shown, the value of log [MFR(1)/MFR(2)] is in a range from about 0.5 to about 0.8. In another embodiment, the value of log [MFR(1)/MFR(2)] is in a range from about 0.6 to about 0.75.

It is notable that the advantageous properties of the multidonor catalyst systems described herein have a relationship between MFR(1) and MFR(2) different from the disclosure of U.S. Pat. No. 6,087,459 to Miro et al. Miro et al appears to discuss a multidonor Ziegler-Natta system, wherein an electron donor “a” and an electron donor “b” separately produce polyolefins satisfying the equation 1.2≦log [MFR(b)/MFR(a)]≦1.4

TABLE 2
Log MFR ratios for U-donor and P-donor employed for
polymerizing propylene. Lynx 1000 ST (320307071) Polymerization
Conditions: 120 min at 80° C., 3.0 MPa in gas phase. Order
of components charging: 0.25 mmol TEA, 23 μm external donor
(at 40° C.; 0.1 MPa N₂), hydrogen (at 0.8 MPa);
catalyst charged into the pressurized reactor (2.1 MPa, 55° C.).

| Avg. H₂ | Log | | | |
|---|---|---|---|---|
| Mole % | (MFR(1)/MFR(2) | MFR(1)/MFR(2) | MFR (1) | MFR (2) |
| 1.18-1.44 | 0.56 | 3.64 | 61.2 | 16.8 |
| 1.63-1.65 | 0.67 | 4.66 | 95.1 | 20.4 |
| 2.19-2.44 | 0.75 | 5.60 | 168.7 | 30.1 |
| 3.09-3.59 | 0.60 | 3.98 | 231.5 | 58.2 |

Additional physical properties of selected olefin polymers produced from the Examples described in Table 2 are shown in Table 3 (particle size distribution), Table 4 (polymerization and viscosity), and Table 5 (isotacticity as determined by NMR).

TABLE 3
Lynx 1000 - U, P, C, U/P (90:10), U/P (80:20) - PSD data
Polymerization in 2LC reactor (PSD data)
Lynx 1000 ST (320307071)
Conditions: Polymerization 120 min at 80° C., 3.0 MPa in gas phase
Order of components charging:
TEA, ext. donor (at 40° C.; 0.1 MPa N2), hydrogen (at 0.8 MPa);
Catalyst charged into the pressurized reactor (2.1 MPa, 55° C.)

| | MFR | PSD | | | | | | | |
|---|---|---|---|---|---|---|---|---|---|
| Ref. | 21 N | d1 | d10 | d30 | d50 | d70 | d90 | d97 | <100mic |
| No. | g/10 min | [micr] | [micr] | [micr] | [micr] | [micr] | [micr] | [micr] | [%] |
| Lynx 1000 ST (320307071) | | | | | | | | | |
| U-donor | | | | | | | | | |
| H924G2C-PSD | 17.9 | 300 | 399 | 508 | 609 | 737 | 981 | 1238 | 0.00 |
| H947G2C-PSD | 231.5 | 329 | 433 | 551 | 660 | 794 | 1059 | 1324 | 0.00 |
| U/P mixture (90:10) | | | | | | | | | |
| H931G2C-PSD | 26.4 | 342 | 468 | 637 | 805 | 1024 | 1404 | 1703 | 0.00 |
| H949G2C-PSD | 212.4 | 337 | 444 | 561 | 670 | 804 | 1064 | 1325 | 0.00 |
| U/P mixture (80:20) | | | | | | | | | |
| H932G2C-PSD | 18.3 | 328 | 445 | 593 | 741 | 934 | 1297 | 1601 | 0.00 |
| H950G2C-PSD | 194.5 | 348 | 455 | 577 | 689 | 830 | 1096 | 1363 | 0.00 |
| P-donor | | | | | | | | | |
| H936G2C-PSD | 16.8 | 350 | 479 | 653 | 825 | 1047 | 1426 | 1721 | 0.00 |
| H944G2C-PSD | 244.1 | 341 | 441 | 546 | 639 | 754 | 961 | 1165 | 0.00 |
| C-donor | | | | | | | | | |
| H926G2C-PSD | 20.41 | 333 | 459 | 625 | 791 | 1008 | 1395 | 1700 | 0.00 |
| H948G2C-PSD | 212.8 | 327 | 422 | 524 | 613 | 721 | 919 | 1113 | 0.00 |

In Table 3, d30 represents the size of particles (diameter) wherein 30% of particles are less than that size, d50 represents the size of particles wherein 50% of particles are less than that size, etc. while no particles have a diameter less than 100 μm. Table 4 shows that the molecular weight (M_{w}) and viscosity of polymers produced by the mixtures of U-donor and P-donor is intermediate to either U-donor or P-donor used alone; however, the M_{w} is closer to that of the minor component P-donor. Table 5 shows that all external electron donors produce polymers with high isotacticity, greater than 97% of olefin polymers comprised of tetrads with identical stereocenter configuration.

TABLE 4
Lynx 1000 - U, P, C, U/P (90:10), U/P (80:20) - GPC data
Polymerization in 2LC reactor (GPC data)
Lynx 1000 ST (320307071)
Conditions: Polymerization 120 min at 80° C., 3.0 MPa in gas phase
Order of components charging:
TEA, ext. donor (at 40° C.; 0.1 MPa N2), hydrogen (at 0.8 MPa);
Catalyst charged into the pressurized reactor (2.1 MPa, 55° C.)

| | MFR | | | | | intrinsic |
|---|---|---|---|---|---|---|
| Ref. | 21 N | | | | | viscosity |
| No. | g/10 min | Mn | Mw | Mz | Mw/Mn | (ml/g)[GPC] |
| Lynx 1000 ST (320307071) | | | | | | |
| U-donor | | | | | | |
| H924G2C-GPC | 17.9 | 60565 | 214650 | 513000 | 3.56 | 174.1 |
| H947G2C-GPC | 231.5 | 41735 | 131500 | 262700 | 3.16 | 129.7 |
| U/P mixture (90:10) | | | | | | |
| H931G2C-GPC | 26.4 | 49360 | 248550 | 691150 | 5.04 | 152.8 |
| H949G2C-GPC | 212.4 | 33685 | 143500 | 361350 | 4.27 | 97.1 |
| U/P mixture (80:20) | | | | | | |
| H932G2C-GPC | 18.3 | 59405 | 263150 | 681100 | 4.45 | 157.2 |
| H950G2C-GPC | 194.5 | 32610 | 146700 | 383500 | 4.53 | 98.7 |
| P-donor | | | | | | |
| H936G2C-GPC | 16.8 | 56130 | 291000 | 784050 | 5.19 | 158.9 |
| H944G2C-GPC | 244.1 | 36150 | 145950 | 361850 | 4.02 | 97.2 |
| C-donor | | | | | | |
| H926G2C-GPC | 20.41 | 72615 | 260300 | 614000 | 3.59 | 156.8 |
| H948G2C-GPC | 212.8 | 36050 | 143350 | 328350 | 3.98 | 97.8 |

TABLE 5
Lynx 1000 - U, P, C, U/P (90:10), U/P (80:20) - NMR data
Lynx 1000 ST (320307071)
Conditions: Polymerization 120 min at 80° C., 3.0 MPa in gas phase
Order of components charging:
TEA, ext. donor (at 40° C.; 0.1 MPa N2), hydrogen (at 0.8 MPa);
Catalyst charged into the pressurized reactor (2.1 MPa, 55° C.)

| | | NMR | | | | | | | | | | | | |
|---|---|---|---|---|---|---|---|---|---|---|---|---|---|---|
| | | | | | | PENTADS | | | | | | | | |
| | MFR | | mmmr | rmmr | mmrr | mrmm + | mrmr | rrrr | rrrm | mrrm | TRIADS | mr | rr | |
| Ref. | 21 N | mmmm | [mol | [mol | [mol | rmrr | [mol | [mol | [mol | [mol | mm | [mol | [mol | avg meso |
| No. | g/10 min | [mol % ] | % ] | % ] | % ] | [mol % ] | % ] | % ] | % ] | % ] | [mol % ] | % ] | % ] | run length |
| Lynx 1000 ST | | | | | | | | | | | | | | |
| (320307071) | | | | | | | | | | | | | | |
| U-donor | | | | | | | | | | | | | | |
| H924G2C | 17.9 | 97.64 | 0.60 | 0.13 | 0.46 | 0.29 | 0.03 | 0.31 | 0.21 | 0.43 | 98.27 | 0.78 | 0.95 | 326 |
| H947G2C | 231.5 | 97.72 | 0.68 | 0.12 | 0.27 | 0.35 | 0.13 | 0.25 | 0.27 | 0.32 | 98.42 | 0.75 | 0.83 | 339 |
| U/P mixture (90:10) | | | | | | | | | | | | | | |
| H931G2C | 26.4 | 97.90 | 0.56 | 0.12 | 0.37 | 0.18 | 0.06 | 0.25 | 0.22 | 0.36 | 98.58 | 0.60 | 0.82 | 348 |
| H949G2C | 212.4 | 98.14 | 0.56 | 0.13 | 0.24 | 0.23 | 0.06 | 0.10 | 0.23 | 0.30 | 98.83 | 0.53 | 0.64 | 351 |
| U/P mixture (80:20) | | | | | | | | | | | | | | |
| H932G2C | 18.3 | 97.73 | 0.67 | 0.25 | 0.43 | 0.20 | 0.05 | 0.18 | 0.22 | 0.27 | 98.65 | 0.68 | 0.67 | 292 |
| H950G2C | 194.5 | 97.62 | 0.70 | 0.17 | 0.36 | 0.28 | 0.08 | 0.19 | 0.28 | 0.32 | 98.49 | 0.73 | 0.79 | 278 |
| P-donor | | | | | | | | | | | | | | |
| H936G2C | 16.8 | 98.11 | 0.60 | 0.16 | 0.33 | 0.26 | 0.04 | 0.14 | 0.17 | 0.20 | 98.86 | 0.63 | 0.51 | 329 |
| H944G2C | 244.1 | 98.02 | 0.66 | 0.12 | 0.32 | 0.33 | 0.06 | 0.09 | 0.22 | 0.18 | 98.80 | 0.71 | 0.49 | 297 |
| C-donor | | | | | | | | | | | | | | |
| H928G2C | 20.41 | 97.04 | 0.94 | 0.20 | 0.71 | 0.25 | 0.05 | 0.22 | 0.23 | 0.37 | 98.18 | 1.01 | 0.81 | 207 |
| H948G2C | 212.8 | 97.28 | 0.95 | 0.14 | 0.63 | 0.29 | 0.06 | 0.12 | 0.22 | 0.30 | 98.37 | 0.99 | 0.64 | 205 |

Net catalytic activity reported in units of kg_{polymer}/(g_{cat}*hr) is calculated by dividing the amount of olefin polymer produced (kg) by the mass of the Ti-based catalyst without external electron donor (g_{cat}) and scaling the resulting value to a time period of one hour. The amount of polymer produce is determined by subtracting the amount of polymer computed to be formed in then condensed phase prior to evaporation of olefin monomers from the total mass of polymer recovered. At any particular point in the polymerization reaction, the instantaneous reaction activity (Rₚ) of olefin polymer production varies.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A catalyst system for polymerizing an olefin, comprising:
a solid titanium catalyst component consisting essentially of a titanium compound and a magnesium support, the solid titanium catalyst support made by contacting a magnesium-containing catalyst support and a titanium compound;
an organoaluminum compound having at least one aluminum-carbon bond; and
at least two organosilicon compounds, wherein one of the at least two organosilicon compounds has a structure according to Formula VI and another of the at least two organosilicon compounds has a structure according to Formula VII: 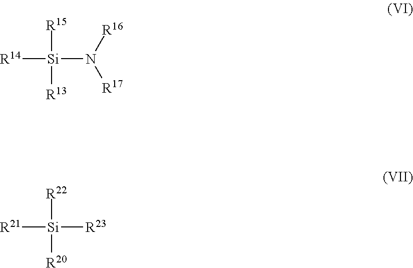
where R¹³, R¹⁴, and R¹⁵ are independently one substituent selected from the group consisting of alkyl substituents having from about 1 to about 10 carbon atoms, alkoxy substituents having from about 1 to about 10 carbon atoms, and aryl substituents having from about 1 to about 10 carbon atoms, R¹⁶ and R¹⁸ are independently one substituent selected from the group consisting of alkyl substituents having from about 1 to about 10 carbon atoms, aryl substituents having from about 1 to about 10 carbon atoms, and hydrogen, and where R²⁰, R²¹, R²², and R²³ are independently one substituent selected from the group consisting of alkyl substituents having from about 1 to about 10 carbon atoms, and alkoxy substituents having from about 1 to about 10 carbon atoms; and
the mole ratio of the organosilicon compound of Formula VI to the organosilicon compound of Formula VII is from about 2.3:1 to about 19:1.

2. The catalyst system of claim 1, wherein the catalyst system has a property that when the catalyst system is contacted with an olefin monomer, and at a pressure of about 3.0 Mpa or less, the MFR of an olefin polymer produced by the catalytic system increases by a factor of at least about 2 as the hydrogen mole percent is varied from about 0.5 to about 1% and net activity is about 20 kg/(g-cat*h) or higher.

3. The catalyst system of claim 1, wherein the catalyst system has a property that when the catalyst system is contacted with an olefin monomer, and at pressure of about 3.0 Mpa or less, the MFR of the olefin polymer produced by the catalytic system increases by a factor of at least about 3 over a range of hydrogen mole percent from about 2 to about 4% and net activity is about 20 kg/(g-cat*h) or higher.

4. The catalyst system of claim 1, wherein the catalyst system has a property that when the catalyst system is contacted with an olefin monomer, and at a pressure of about 3.0 Mpa or less, the MFR of the olefin polymer produced by the catalytic system increases by a factor of at least about 2 over a range of hydrogen mole percent from about 1 to about 2%.

5. The catalyst system of claim 1, wherein the mole ratio of the organosilicon compound of Formula VI to the organosilicon compound of Formula VII is from about 4:1 to about 19:1.

6-7. (canceled)

8. The catalyst system of claim 1, wherein the catalyst system is in a slurry form or in a dry form.

9. The catalyst system of claim 1, wherein the organoaluminum compound is one or more selected from the group consisting of Formula (IV) and Formula (V):
Rₘ¹¹Al(OR¹²)ₙHₚX_{q}¹ (IV),
Mᵣ¹AlR₃₋ᵣ¹¹ (V);
where R¹¹ and R¹², independently, are a hydrocarbon group having from 1 to about 15 carbon atoms, X¹ represents a halogen atom, 0<q≦3, 0 [symbol] p≦3, 0 [symbol] n≦3, 0<r≦3, and m+n+p+q=3; and
wherein M¹ is selected from the group consisting of Li, Na or K, and R¹¹.

10. A catalyst system for polymerizing an olefin to form a polyolefin, comprising:
a Ziegler-Natta catalyst, with the proviso that the Ziegler-Natta catalyst does not comprise an internal electron donor; and
at least two organosilicon compounds, wherein one of the at least two organosilicon compounds has a structure according to Formula VI and another of the at least two organosilicon compounds has a structure according to Formula VII: 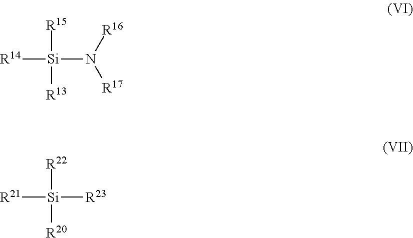
where R¹³, R¹⁴, and R¹⁵ are independently one substituent selected from the group consisting of alkyl substituents having from about 1 to about 10 carbon atoms, alkoxy substituents having from about 1 to about 10 carbon atoms, and aryl substituents having from about 1 to about 10 carbon atoms, R¹⁶ and R¹⁷ are independently one substituent selected from the group consisting of alkyl substituents having from about 1 to about 10 carbon atoms, aryl substituents having from about 1 to about 10 carbon atoms, and hydrogen, and where R²⁰, R²¹, R²², and R²³ are independently one substituent selected from the group consisting of alkyl substituents having from about 1 to about 10 carbon atoms, and alkoxy substituents having from about 1 to about 10 carbon atoms, and
wherein the catalyst system has a property that when the catalyst system is contacted with an olefin monomer, and at pressure of about 3.0 Mpa or less, the ratio of MFR for the polyolefin expressed in units of g (10 min)⁻¹ to the mole percentage of hydrogen expressed in percent units is greater than about 14:1, and
the mole ratio of the organosilicon compound of Formula VI to the organosilicon compound of Formula VII is from about 2.3:1 to about 19:1.

11. The catalyst system of claim 10, the ratio of MFR for the polyolefin expressed in units of g (10 min)⁻¹ to the mole percentage of hydrogen expressed in percent units is greater than about 25:1.

12. The catalyst system of claim 10, the ratio of MFR for the polyolefin expressed in units of g (10 min)⁻¹ to the mole percentage of hydrogen expressed in percent units is greater than about 35:1

13. A method of making a polyolefin, comprising:
contacting an olefin with a catalyst system comprising a solid titanium catalyst component, the solid titanium catalyst component consisting essentially of a titanium compound and a support; and at least two organosilicon compounds, wherein one of the at least two organosilicon compounds has a structure according to Formula VI: 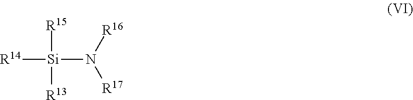
where R¹³, R¹⁴, and R¹⁵ are independently one substituent selected from the group consisting of alkyl substituents having from about 1 to about 10 carbon atoms, alkoxy substituents having from about 1 to about 10 carbon atoms, and aryl substituents having from about 1 to about 10 carbon atoms, R¹⁶ and R¹⁷ are independently one substituent selected from the group consisting of alkyl substituents having from about 1 to about 10 carbon atoms, aryl substituents having from about 1 to about 10 carbon atoms, and hydrogen, and
wherein the ratio of MFR for the polyolefin expressed in units of g (10 min)⁻¹ to the mole percentage of hydrogen in percent units is greater than about 14:1 when the mole percent of hydrogen is from about 0.2 to about 2%, the ratio of MFR for the polyolefin expressed in units of g (10 min)⁻¹ to the mole percentage of hydrogen expressed in percent units is greater than about 25:1 when the mole percent of hydrogen is from about 2 to about 3%, and the ratio of MFR for the polyolefin expressed in units of g (10 min)⁻¹ to the mole percentage of hydrogen expressed in percent units is greater than about 35:1 when the mole percent of hydrogen is from about 3 to about 6%,
wherein the mole ratio of the organosilicon compound of Formula VI to the other of the at least two organosilicon compounds is from about 2.3:1 to about 19:1.

14. The method of claim 13, wherein net activity is about 20 kg/(g-cat*h) or higher.

15. The method claim 14, wherein another of the at least two organosilicon compounds has a structure of Formula VII: 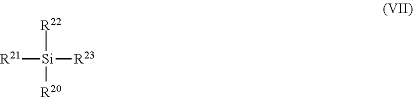
where R²⁰, R²¹, R²², and R²³ are independently one substituent selected from the group consisting of alkyl substituents having from about 1 to about 10 carbon atoms, and alkoxy substituents having from about 1 to about 10 carbon atoms.

16. The method of claim 14, wherein the mole ratio of the organosilicon compound of Formula VI to the organosilicon compound of Formula VII is from about 1:1 to 19:1.

17. The method of claim 14, wherein the mole ratio of the organosilicon compound of Formula VI to the organosilicon compound of Formula VII is from about 4:1 to 19:1.

18. The method of claim 14, wherein the mole ratio of the organosilicon compound of Formula VI to the organosilicon compound of Formula VII is from about 2.3:1 to about 19:1.

19. The method of claim 13, wherein the isotacticity of the polyolefin is characterized by mmmm pentads having identical stereocenters forming at least 97% of the polyolefin.

20. The method of claim 13, wherein the olefin comprises propylene.

21. The method of claim 13, wherein the olefin contacted with the catalyst system is in one or more of a gaseous phase and a liquid phase.

22. A multidonor catalyst system for polymerizing an olefin, comprising:
a solid titanium catalyst component consisting essentially of a titanium compound and a support;
an organoaluminum compound having at least one aluminum-carbon bond;
a first external electron donor and a second external electron donor, wherein the first external electron donor combined with a reference system for polymerizing an olefin produces a first polyolefin having a melt flow rate of MFR(1), and the second electron donor combined with the reference system for polymerizing an olefin produces a second polyolefin having a melt flow rate of MFR(2), where the reference system comprises the solid titanium catalyst and the organoaluminum compound,
wherein the molar amount of the first external electron donor present in the multidonor catalyst system is greater than the molar amount of the second external electron donor present in the multidonor catalyst system, and
the value of log [MFR(1)/MFR(2)] is from about 0.5 to about 0.8, and
the mole ratio of the first external electron donor to the second external electron donor is from about 2.3:1 to about 19:1.

23. The multidonor catalyst system of claim 22, wherein the first external electron donor has a structure of Formula VI and the second external electron donor has a structure of Formula VII: 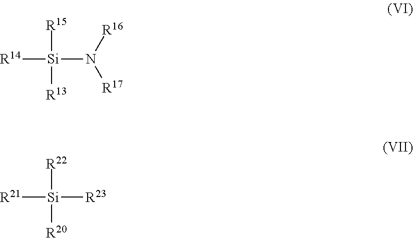
where R¹³, R¹⁴, and R¹⁵ are independently one substituent selected from the group consisting of alkyl substituents having from about 1 to about 10 carbon atoms, alkoxy substituents having from about 1 to about 10 carbon atoms, and aryl substituents having from about 1 to about 10 carbon atoms, R¹⁶ and R¹⁸ are independently one substituent selected from the group consisting of alkyl substituents having from about 1 to about 10 carbon atoms, aryl substituents having from about 1 to about 10 carbon atoms, and hydrogen, and where R²⁰, R²¹, R²², and R²³ are independently one substituent selected from the group consisting of alkyl substituents having from about 1 to about 10 carbon atoms, and alkoxy substituents having from about 1 to about 10 carbon atoms.

24. (canceled)

25. The multidonor catalyst system of claim 23, wherein the mole ratio of the first external electron donor to the second external electron donor is from about 4:1 to about 19:1.

26. (canceled)
